(19) United States
(12) Patent Application Publication
(10) Pub. No.: US 2005/0148752 A1
(43) Pub. Date: Jul. 7, 2005

(54) Amino-functional polysiloxanes and their use in coatings

(76) Inventors: Lars Ivar Klaassens, Haarlem (NL); Jan De Jong, Zaandam (NL); Henk Van Der Poel, Voorhout (NL); Christopher Slingeneijer De Goeswin, Hensies (BE); Sibel Mill, Riemerling (DE)

Correspondence Address: KNOBBE MARTENS OLSON & BEAR LLP, 2040 MAIN STREET, FOURTEENTH FLOOR, IRVINE, CA, 92614, US

(21) Appl. No.: 10/512,940

(22) PCT Filed: Apr. 30, 2003
(86) PCT No.: PCT/EP03/04513

(30) Foreign Application Priority Data
May 3, 2002 (EP) 024470791
May 3, 2002 (EP) 024470817

(51) Int. Cl. C08G 77/26

(52) U.S. Cl. 528/38

(57) ABSTRACT

The present invention relates to an amino-functional polysiloxane of formula (1) where each R¹ is independently selected from alkyl or aryl radicals, each R² is independently selected from hydrogen, alkyl or aryl radicals, n is selected so that the molecular weight for the functional polysiloxane is in the range of from 400 to 10,000 and R³ is a bivalent radical or —O—R³—NH—R⁵ is hydroxy or alkoxy, and R⁵ is selected from hydrogen, aminoalkyl, aminoalkenyl, aminoaryl, aminocycloalkyl radical, optionally substituted by alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl or alkynyl and where 0 to 90% of —O—R³—NH—R⁵ is hydroxy or alkoxy. The present invention further relates to an epoxy-polysiloxane composition which includes an aminopolysiloxane hardener component or an amino-functional polysiloxane hardener component of formula (1), having active hydrogens able to react with epoxy groups in an epoxy resin to form epoxy polymers, and able to react with a polysiloxane to form polysiloxane polymers, wherein the epoxy chain polymers and polysiloxane polymers polymerize to form a cured epoxy-polysiloxane polymer composition.

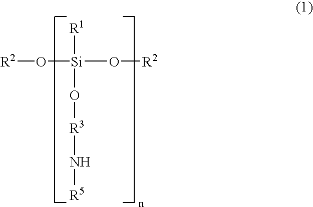

### FIELD OF THE INVENTION

This invention relates to new amino-functional polysiloxanes useful as resins. This invention also relates to the use of these amino-functional polysiloxanes in resin-based compositions useful for protective coatings and the like. This invention further relates to epoxy-polysiloxane resin based compositions useful for protective coatings and the like having improved gloss retention.

### BACKGROUND

Polysiloxanes are known to give interesting properties as resins and coatings. True advancements in the state-of-the-art for protective coatings require substantial improvements in weathering (primarily resistance to ultraviolet radiation), heat resistance, chemical resistance and corrosion control. Polysiloxane chemistry offers the potential for providing many of these advancements. Polysiloxane is defined as a polymer consisting of repeating silicon-oxygen atoms in the backbone that imparts several advantages over previously used carbon-based polymer binders; one of these advantages being an enhanced chemical and thermal resistance due to the silicon-oxygen bond. Polysiloxane's polymer linkage is also transparent to ultraviolet light making it resistant to degradation by ultraviolet radiation. Finally, polysiloxane is not combustible and is resistant to a wide range of chemicals and solvents, including acids.

Amino-functional siloxanes have been described. U.S. Pat. No. 4,413,104 to Wacker describes a process for preparing amino-functional polysiloxanes and copolymers thereof. These amino-functional polysiloxanes possess a Si—C bond between the polymeric polysiloxane backbone and the functional linking arm. Furthermore, DE 1 125 171 to Schering describes a process for preparing amino-functional siloxanes.

Epoxy-based protective coating materials are well known and have gained commercial acceptance as protective and decorative coatings for steel, aluminum, galvanized steel and concrete in maintenance, marine, construction, architectural, aircraft and product finishing markets. The basic raw materials used to prepare these coatings generally comprise as essential components (a) an epoxy resin, (b) a hardener and (c) a pigment or filler component.

Epoxy-based protective coatings possess many properties which make them desirable as coating materials. They are readily available and are easily applied by a variety of methods including spraying, rolling and brushing. They adhere well to steel, concrete and other substrates, have low moisture vapor transmission rates and act as barriers to water, chloride and sulfate ion ingress, provide excellent corrosion protection under a variety of atmospheric exposure conditions and have good resistance to many chemicals and solvents. Epoxy-based coatings generally show excellent protective properties, but have a considerable drawback which is the limited gloss and color retention when atmospherically exposed.

Epoxy-polysiloxane based compounds are known from U.S. Pat. No. 5,618,860. Although epoxy-polysiloxane based coating materials generally do have resistance to weathering in sunlight, some of them still have poor gloss retention.

Thus, while epoxy-polysiloxane based coating materials have gained commercial acceptance, the need nevertheless remains for epoxy-polysiloxane based materials with improved properties. Coating materials with improved gloss retention are needed for both primary and secondary chemical containment structures, for protecting steel and concrete in chemical, power generation, rail car, sewage and waste water treatment, and paper and pulp processing industries.

It is an object of the present invention to provide new amino-functional polysiloxanes with a great variety in amine structures, which can be prepared with a simple method. It is another object to introduce amino-functional groups on a polysiloxane backbone, which are reactive, e.g. with epoxy radicals. It is yet another object of the present invention to provide new polymer compositions comprising said amino-functional polysiloxane, with improved hardness development. It is another object to provide new polymer compositions comprising said amino-functional polysiloxane having improved gloss retention, and weathering resistance. A further object of the present invention is therefore to provide an epoxy-polysiloxane based coating composition having improved gloss retention while other properties like curing, hardness development, and chemical resistance are preserved.

### SUMMARY OF THE INVENTION

In a first aspect of the present invention, novel amino-functional polysiloxanes of formula (1) are described, wherein each R¹ is independently selected from the group comprising alkyl and aryl, each R² is independently selected from the group comprising hydrogen, alkyl and aryl radicals, n is selected so that the molecular weight for the functional polysiloxane is in the range of from 400 to 10,000 and R³ is a bivalent radical or —O—R³—NH—R⁵ is hydroxy or alkoxy, and R⁵ is selected from the group comprising hydrogen, or aminoalkyl, aminoalkenyl, aminoaryl, aminocycloalkyl radical, optionally substituted by alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl or alkynyl and wherein 0 to 90% of —O—R³—NH—R⁵ is hydroxy or alkoxy.

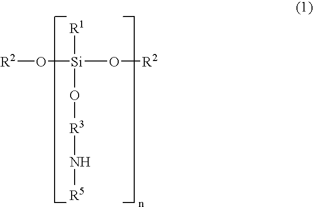

According to an embodiment, the amino-functional polysiloxane of formula (1) has preferably the following stoichiometric formula

$${R}_{a}^{1} {{R}_{b}^{2} ( {R}^{9} O )}_{c} {SiO}_{\frac{( 4 - a - b - c )}{2}} ,$$

wherein each R⁹ is independently selected from hydrogen, alkyl, or —R³—NH—R⁵, and R¹, R², have the same meaning as that defined above, a and b are each a real number from 0.0 to 2.0, more in particular from 0.1 to 2.0, c is a real number from 0.1 to 1.0, b/a is ranging from 0.2-2.0 and a+b+c is lower than 4, and wherein 0 to 90% of —O—R⁹ is hydroxy or alkoxy. In the above stoichiometric formula, a is preferably from 1.4 to 0.4, b is preferably from 0.5 to 1.5 and c is preferably from 0.1 to 0.4.

Said amino-functional polysiloxane possesses a Si—O—C bond between the polymeric backbone and the functional group.

These novel compounds contain at least one basic nitrogen which is bonded to silicon via an oxygen and which has at least one hydrogen atom directly bonded to it.

In a second aspect, the present invention relates to a method for the preparation of amino-functional polysiloxane of formula (1). The method of the present invention provides the advantage of being a simple one step synthesis of said amino-functional polysiloxane from available polysiloxane.

The present invention further relates to the use of said amino-functional polysiloxane as hardener and in a coating.

The present invention further provides new polymer compositions comprising said amino-functional polysiloxane of formula (1) and to a method of preparation thereof. Said polymers show improved hardness development and improved gloss retention and weathering resistance.

In a third aspect, an epoxy-polysiloxane composition is prepared, according to principles of this invention, by combining the following ingredients:
a polysiloxane of formula (4), wherein each R^{1′} is independently selected from the group comprising hydroxy, alkyl, aryl and alkoxy radicals having up to six carbon atoms, each R² is independently selected from the group comprising hydrogen, alkyl and aryl radicals having up to six carbon atoms and, wherein n is selected so that the molecular weight for the polysiloxane is in the range of from about 400 to 10,000; 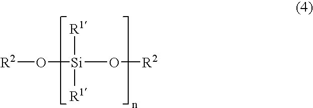
an epoxy resin having more than one 1,2-epoxy groups per molecule with an epoxy equivalent weight in the range of from 100 to about 5,000; and
aminopolysiloxane hardener component, or an amino-functional polysiloxane hardener component of formula (1) as described herein having active hydrogens able to react with the epoxy groups in the epoxy resin to form epoxy polymers, and able to react with the polysiloxane to form polysiloxane polymers, wherein the epoxy chain polymers and polysiloxane polymers polymerize to form a cured epoxy-polysiloxane polymer composition.

The aminopolysiloxane hardener may be any amino-functional polysiloxane. Amino-functional polysiloxanes are known from U.S. Pat. No. 3,890,269, EP 02 830 09, U.S. Pat. No. 4,413,104, U.S. Pat. Nos. 4,972,029 and 4,857,608, EP 0 887 366 and U.S. Pat. No. 3,941,856 hereby incorporated by reference. U.S. Pat. No. 3,890,269 relates to a process for the preparation of amino-functional polysiloxane polymers by equilibrating a mixture containing a cyclic organo-polysiloxane with an amino functional silicon compound in the presence of a catalyst.

U.S. Pat. No. 4,857,608 relates to a process for preparing a coating by modifying epoxy resins with organosilicon compounds containing a basic nitrogen which is bonded to silicon via a carbon and which has at least one hydrogen atom directly bonded to it. Preferred examples are illustrated in column 2 from line 5 up to column 3 line 49. These known aminopolysiloxanes are suitable as a hardener for the present invention.

The epoxy-polysiloxane composition is prepared by using in the range of from about 10 to 80% by weight polysiloxane, 10 to 50% by weight of the epoxy resin ingredient, 5 to 40% by weight of the aminopolysiloxane hardener, and optionally up to about 5% by weight catalyst.

It is assumed that the above-identified ingredients react to form a network composition that comprises a continuous phase epoxy-polysiloxane copolymer. Epoxy-polysiloxane compositions of this invention display improved resistance to ultraviolet light and weathering in sunlight without impairing chemical and corrosion resistance when compared to conventional epoxy resin based coatings. Additionally, epoxy-polysiloxane compositions of this invention display improved color and gloss retention that reaches a level exhibited by topclass aliphatic polyurethanes and may obviate the need for top coating.

### DETAILED DESCRIPTION

In a first aspect, the present invention relates to amino-functional polysiloxane of formula (1) as described above. It is to be understood that formula (1) is illustrative only, and that the amino-functional polysiloxane according to the invention may contain from 0 to 90% of alkoxy or hydroxy radicals.

As used herein, the term “independently selected” indicates that the each radical R so described, can be identical or different. For example, each R¹ in polysiloxane of formula (1) may be different for each value of n, and within each unit of said polysiloxane

As used herein “a real number” refers to a number which is positive and includes integers and fractions of integers or any rational or irrational number. For example a is a real number from 0.0 to 2.0 means that a may assume any value within the range from 0.0 to 2.0.

As used herein, the term “alkyl”, alone or in combination, means straight and branched chained saturated hydrocarbon radicals containing from 1 to 10 carbon atoms, preferably from 1 to 8 carbon atoms, more preferably 1-6 carbon atoms. Examples of such radicals include methyl, ethyl, n-propyl, isopropyl, n-butyl, isobutyl, sec-butyl, tert-butyl, 2-methylbutyl, pentyl, iso-amyl, hexyl, 3-methylpentyl, octyl, 2-ethylhexyl and the like.

As used herein, the term “alkenyl”, alone or in combination, defines straight and branched chained hydrocarbon radicals containing from 2 to about 18 carbon atoms, preferably from 2 to 8 carbon atoms, more preferably 2-6 carbon atoms containing at least one double bond such as, for example, ethenyl, propenyl, butenyl, pentenyl, hexenyl and the like.

The term “alkenylene”, alone or in combination, defines bivalent straight and branched chained hydrocarbon radicals containing from 2 to about 18 carbon atoms, preferably from 2 to 8 carbon atoms, more preferably 2-6 carbon atoms containing at least one double bond such as, for example, ethenylene, propenylene, butenylene, pentenylene, hexenylene and the like.

The term “alkoxy” or “alkyloxy”, alone or in combination, means alkyl ether radical wherein the term alkyl is as defined above. Examples of suitable alkyl ether radicals include methoxy, ethoxy, n-propoxy, isopropoxy, n-butoxy, iso-butoxy, sec-butoxy, tert-butoxy, hexanoxy and the like.

The term “alkylene”, alone or in combination, defines bivalent straight and branched chained saturated hydrocarbon radicals containing from 1 to 10 carbon atoms, preferably from 1 to 8 carbon atoms, more preferably 1-6 carbon atoms such as, for example, methylene, ethylene, propylene, butylene, pentylene, hexylene and the like.

The term “alkynyl”, alone or in combination, defines straight and branched chained hydrocarbon radicals having from 2 to 10 carbon atoms containing at least one triple bond, more preferably from 2 to about 6 carbon atoms. Examples of alkynyl radicals include ethynyl, propynyl, (propargyl), butynyl, pentynyl, hexynyl and the like.

The term “aminoalkylene” means a bivalent alkylene amine radical, wherein the term “alkylene” is defined as above. Examples of aminoalkylene radicals include aminomethylene (—CH₂NH—), aminoethylene (—CH₂CH₂NH—), aminopropylene, aminoisopropylene, aminobutylene, aminoisobutylene, aminohexylene and the like.

The term “aralkyl” alone or in combination, means an alkyl as defined herein, wherein an alkyl hydrogen atom is replaced by an aryl as defined herein. Examples of aralkyl radicals include benzyl, phenethyl, dibenzylmethyl, methylphenylmethyl, 3-(2-naphthyl)-butyl, and the like.

The term “aralkylene” as used herein, relates to a group of the formula alkylene-arylene in which alkylene is as defined above. Examples of aralkylene radicals include benzylene, phenethylene and the like.

The term “aryl” alone or in combination, is meant to include phenyl and naphtyl which both may be optionally substituted with one or more substituents independently selected from alkyl, alkoxy, halogen, hydroxy, amino, nitro, cyano, haloalkyl, carboxy, alkoxycarbonyl, cycloalkyl, heterocycle, amido, optionally mono- or disubstituted aminocarbonyl, methylthio, methylsulfonyl, and phenyl optionally substituted with one or more substituents selected from alkyl, alkyloxy, halogen, hydroxy, optionally mono- or disubstituted amino, nitro, cyano, haloalkyl, carboxyl, alkoxycarbonyl, cycloalkyl, heterocycle, optionally mono- or disubstituted aminocarbonyl, methylthio and methylsulfonyl; whereby the optional substituents on any amino function are independently selected from alkyl, alkyloxy, heterocycle, heterocycloalkyl, heterocyclooxy, heterocyclooxyakyl, phenyl, phenyloxy, phenyloxyalkyl, phenylalkyl, alkyloxycarbonylamino, amino, and aminoalkyl whereby each of the amino groups may optionally be mono- or where possible di-substituted with alkyl. Examples of aryl includes phenyl, p-tolyl, 4-methoxyphenyl, 4-(tert-butoxy)phenyl, 3-methyl-4-methoxyphenyl, 4-fluorophenyl, 4-chlorophenyl, 3-nitrophenyl, 3-aminophenyl, 3-acetamidophenyl, 4-acetamidophenyl, 2-methyl-3-acetamidophenyl, 2-methyl-3-aminophenyl, 3-methyl-aminophenyl, 2-amino-3-methylphenyl, 2,4-dimethyl-3-aminophenyl, 4-hydroxyphenyl, 3-methyl-4-hydroxyphenyl, 1-naphthyl, 2-naphthyl, 3-amino-1-naphthyl, 2-methyl-3-amino-1-naphthyl, 6-amino-2-naphthyl, 4,6-dimethoxy-2-naphthyl and the like.

The term “arylene” as used herein, includes a bivalent organic radical derived from an aromatic hydrocarbon by removal of two hydrogens, such as phenylene.

The term “cycloalkyl” alone or in combination, means a saturated or partially saturated monocyclic, bicyclic or polycyclic alkyl radical wherein each cyclic moiety contains from about 3 to about 8 carbon atoms, more preferably from about 3 to about 7 carbon atoms. Examples of monocyclic cycloalkyl radicals include cyclopropyl, cyclobutyl, cyclopentyl, cyclohexyl, cycloheptyl, cyclodecyl and the like. Examples of polycyclic cycloalkyl radicals include decahydronaphthyl, bicyclo [5.4.0] undecyl, adamantyl, and the like.

The term “cycloalkylalkyl” means an alkyl radical as defined herein, in which at least one hydrogen atom on the alkyl radical is replaced by a cycloalkyl radical as defined herein. Examples of such cycloalkylalkyl radicals include cyclopropylmethyl, cyclobutylmethyl, cyclopentylmethyl, cyclohexylmethyl, 1-cyclopentylethyl, 1-cyclohexylethyl, 2-cyclopentylethyl, 2-cyclohexylethyl, cyclobutylpropyl, cyclopentylpropyl, 3-cyclopentylbutyl, cyclohexylbutyl and the like.

The term “haloalkyl” alone or in combination, means an alkyl radical having the meaning as defined above wherein one or more hydrogens are replaced with a halogen, preferably, chloro or fluoro atoms, more preferably fluoro atoms. Examples of such haloalkyl radicals include chloromethyl, 1-bromoethyl, fluoromethyl, difluoromethyl, trifluoromethyl, 1,1,1-trifluoroethyl and the like.

As used herein, the term “halo” or “halogen” as a group or part of a group is generic for fluoro, chloro, bromo or iodo.

The term “heterocycle” alone or in combination, is defined as a saturated or partially unsaturated or aromatic monocyclic, bicyclic or polycyclic heterocycle having preferably 3 to 12 ring members, more preferably 5 to 10 ring members and more preferably 5 to 8 ring members, which contains one or more heteroatom ring members selected from nitrogen, oxygen or sulfur and which is optionally substituted on one or more carbon atoms by alkyl, alkyloxy, halogen, hydroxy, oxo, optionally mono- or disubstituted amino, nitro, cyano, haloalkyl, carboxyl, alkoxycarbonyl, cycloalkyl, optionally mono- or disubstituted aminocarbonyl, methylthio, methylsulfonyl, aryl and a saturated or partially unsaturated or aromatic monocyclic, bicyclic or tricyclic heterocycle having 3 to 12 ring members which contains one or more heteroatom ring members selected from nitrogen, oxygen or sulfur and whereby the optional substituents on any amino function are independently selected from alkyl, alkyloxy, heterocycle, heterocycloalkyl, heterocyclo-oxy, heterocyclo-oxyalkyl, aryl, aryloxy, aryloxyalkyl, aralkyl, alkyloxycarbonylamino, amino, and aminoalkyl whereby each of the amino groups may optionally be mono- or where possible di-substituted with alkyl.

The term “heterocycloalkyl” means alkyl as defined herein, wherein an alkyl hydrogen atom is replaced by a heterocycle as defined herein. Examples of heterocycloalkyl radicals include 2-pyridylmethyl, 3-(4-thiazolyl)-propyl, and the like.

As used herein, the term (C═O) forms a carbonyl moiety with the carbon atom to which it is attached.

The term “alkylthio” means an alkyl thioether radical, wherein the term “alkyl” is defined as above. Examples of alkylthio radicals include methylthio (SCH₃), ethylthio (SCH₂CH₃), n-propylthio, isopropylthio, n-butylthio, isobutylthio, sec-butylthio, tert-butylthio, n-hexylthio, and the like.

According to an embodiment, the present invention relates to amino-functional polysiloxane of formula (1) wherein the bivalent radical R³ may be selected from the group comprising alkylene, alkyleneoxy, alkenylene, arylene, aralkylene, aralkenylene, aminoalkylene, alkyleneoxyaralkyloxyalkylene, CH₂-phenyl-(CH₂)ₙ—, -phenyl-(CH₂)ₙ—, —C(═O)—, —C(═S)—, —S(═O)₂—, alkylene-C(═O)—, alkylene-C(═S)—, alkylene-S(═O)₂—, —NR⁴—C(═O)—, —NR⁴-alkylene-C(═O)—, or —NR⁴—S(═O)₂ whereby either the C(═O) group or the S(═O)₂ group is attached to the NR⁴ moiety, optionally substituted by alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, alkylcarboxy, ester, alkylester, ether, esteroxy, sulfonic acid, sulfonyl derivatives, sulfinyl derivatives, heterocycle, alkenyl or alkynyl, wherein R⁴ is hydrogen, alkyl, alkenyl, aralkyl, cycloalkyl, cycloalkylalkyl, aryl, heterocycle or heterocycloalkyl. According to another embodiment, the radical —O—R³—NH—R⁵ may be a radical of formula (1′), 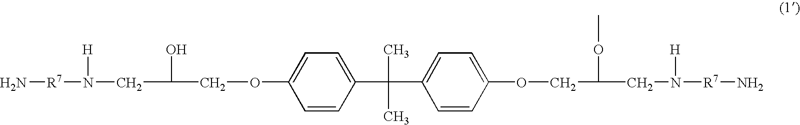
wherein R⁷ is selected from the group comprising alkyl, alkenyl, aryl, cycloalkyl radical, optionally substituted by alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl or alkynyl.

More in particular the present invention relates to amino-functional polysiloxane of formula (1) wherein R³ may be alkylene, alkenylene, arylene, aralkylene, aralkenylene, aminoalkylene, alkyleneoxy, alkyleneoxyaralkyloxyalkylene, CH₂-phenyl-(CH₂)ₙ—, -phenyl-(CH₂)ₙ—, optionally substituted by alkyl, aryl, cycloalkyl, hydroxy, alkoxy, thioalkyl, amino, amino derivatives, amido, amidoxy, acyl derivatives, acyloxy derivatives, carboxy, alkylcarboxy, ester, alkylester, ether, esteroxy, heterocycle, alkenyl or alkynyl.

Examples of aminoalkyl radicals represented by R⁵ are selected from the group comprising H₂N(CH₂)₃—, H₂N(CH₂)₂—, H₂N(CH₂)₄—, H₂N—(CH₂)₂—NH—(CH₂)₂—NH—(CH₂)₂—, and C₄H₉—NH(CH₂)₂NH(CH₂)₂—,

A preferred hardener consist of units as depicted in formula (2′) 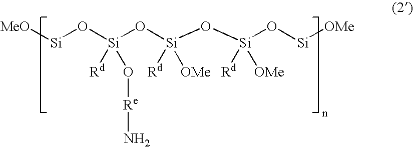
wherein R^{d} is an alkyl or an aryl and R^{e} may be selected from the group comprising alkylene, alkenylene, arylene, aralkylene, aralkenylene, aminoalkylene, alkyleneoxy, alkyleneoxyaralkyloxyalkylene, CH₂-phenyl-(CH₂)ₙ—, -phenyl-(CH₂)ₙ—, optionally substituted by alkyl, aryl, cycloalkyl, hydroxy, alkoxy, thioalkyl, amino, amino derivatives, amido, amidoxy, acyl derivatives, acyloxy derivatives, carboxy, alkylcarboxy, ester, alkylester, ether, esteroxy, heterocycle, alkenyl or alkynyl. In an embodiment, R^{d} is selected from the group comprising methyl, ethyl, propyl and phenyl, and R^{e} is selected from the group comprising methylene, ethylene and propylene.

Non-limiting examples of amino-functional polysiloxane according to the invention include those described in the examples and those listed in Table 1.

These amino-functional polysiloxanes have a good reactivity as hardener as they contain at least one primary amine functional moiety providing a better cross-linking reaction in a polymeric composition such as a coating. The amino-functional polysiloxanes according to this invention are new polymers easily produced from commercial polysiloxanes and their functionality in amines can be broad. They are suitable as hardeners with epoxy resins and can exhibit fast curing at room temperature and good hardness development.

In a second aspect, the present invention relates to a method for the preparation of the above-described amino-functional polysiloxane of formula (1). Said method comprises the step of reacting a polysiloxane of formula (2) with an amino-alcohol of formula (3) comprising at least one hydroxyl and at least one primary amine, optionally in the presence of a suitable catalyst, wherein R¹, R², R³, R⁵ and n have the same meaning as that defined above, and R⁶ is a radical selected from the group comprising hydrogen, alkyl and aryl radicals.

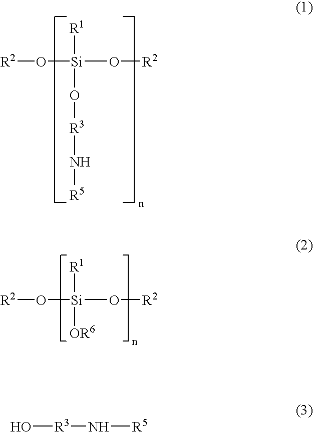

According to an embodiment, the polysiloxane of formula (2) has preferably the following stoichiometric formula

$${R}_{a}^{1} {{R}_{b}^{2} ( {R}^{6} O )}_{c} {SiO}_{\frac{( 4 - a - b - c )}{2}} ,$$

wherein R¹, R², R⁶ have the same meaning as that defined above, a and b are each a real number from 0.0 to 2.0, more in particular from 0.1 to 2.0, c is a real number from 0.1 to 1.0, b/a is ranging from 0.2-2.0 and a+b+c is lower than 4.

Suitable polysiloxanes of formula (2) may have a molecular weight ranging from 500 to 6000 and an alkoxy content ranging from 10 to 50%.

Examples of suitable polysiloxanes of formula (2) for said process include the alkoxy- and silanol-functional polysiloxanes. Suitable alkoxy-functional polysiloxanes include, but are not limited to: DC-3074 and DC-3037 from Dow Corning; Silres SY-550, and SY-231 from Wacker Silicone; and Rhodorsil Resin 10369 A, Rhodorsil 48V750, 48V3500 from Rhodia Silicones; and SF1147 from General Electrics. Suitable silanol-functional polysiloxanes include, but are not limited to, Silres SY 300, Silres SY 440, Silres MK and REN 168 from Wacker Silicone, Dow Corning's DC-840, DC233 and DG431 HS silicone resins and DC-Z-6018 intermediate and Rhodia Silicones' Rhodorsil Resin 6407 and 6482 X.

In order to obtain said amino-functional polysiloxane of formula (1) polysiloxane starting material of formula (2) may be reacted with any suitable aminoalcohol of formula (3). Said reaction may be partial or total, and the amino-functional polysiloxane obtained at the end of the reaction may contain from 0 to 90% of alkoxy or hydroxy radicals.

Examples of suitable aminoalcohol of formula (3) according to the invention, include but are not limited to 2-amino-1-ethanol, 1-amino-2-propanol, 2-amino-1-propanol, 3-amino-1-propanol, 2-amino-1-butanol, 3-amino-1-butanol, neopentanolamine (3-amino-2,2-dimethyl-1-propanol), 2-amino-1-methyl-1-propanol, 2-amino-2-methyl-1-propanol, 2-amino-2-ethylpropane-1,3-diol, 2-amino-2-methylpropane-1,3-diol, 5-amino-1-pentanol, 1,2-dimethylethanolamine, 3-alloxy-2-hydroxy-propylamine, 1-amino-2-methyl-pentanol, N-methylethanolamine, N-hydroxyethylpropanediamine, N-cyclohexylethanolamine, p-(beta-hydroxyethyl)-aniline, N-(beta-hydroxypropyl)-N′-(beta-aminoethyl)piperazine, 2-hydroxy-3-(m-ethylphenoxy)propylamine, 2-hydroxy-2-phenylethyl amine, tris(hydroxymethyl)aminomethane, 2-aminobenzyl alcohol, 3-aminobenzyl alcohol, 3-amino-o-cresol, 4-amino-o-cresol, 5-amino-o-cresol, 2-amino-p-cresol, 4-amino-m-cresol, 6-amino-m-cresol, 1-amino-1-cyclopentane methanol, 2-(2-aminoethoxy)ethanol, 2-(2-aminoethylamino)ethanol, 6-amino-1-hexanol, 3-(1-hydroxyethyl)aniline, 2-amino-1-phenylethanol, 1-aminomethyl-1-cyclohexanol, 8-amino-2-naphthol, 2-amino-phenethyl alcohol, 4-aminophenethyl alcohol, 3-(alpha-hydroxyethyl)aniline, Mannich bases, the reaction product of an aminoalcohol with cis-2-pentenenitrile followed by an hydrogenation step, aminophenols such as p-aminophenol, tyrosine, tyramine and the like, epoxy-amine adducts and mixtures thereof. According to another embodiment, more suitable aminoalcohol of formula (3) may be selected from the group comprising 2-amino-1-ethanol, 2-amino-1-butanol, 1-amino-2-propanol, 2-amino-1-propanol, 3-amino-1-propanol, 2-(2-aminoethoxy)ethanol, 2-(2-aminoethylamino)ethanol.

According to another embodiment, aminoalcohols of formula (3) according to the invention can be epoxy amine adducts. These aminoalcohols are the result of a reaction between an epoxy and amine, and may be defined as higher molecular weight amines (with epoxy backbone). For examples these aminoalcohols can be of formula (5), (6) or (7), wherein R⁷ is selected from the group comprising alkyl, alkenyl, aryl, cycloalkyl radical, optionally substituted by alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl or alkynyl and R⁸ is selected from the group comprising linear or branched aliphatic radicals, preferably branched C₁₋₂₀ alkyl radical.

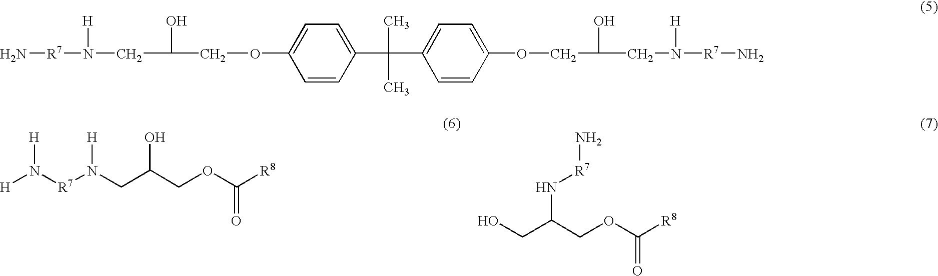

These aminoalcohols can be obtained by the reaction of an epoxy with a polyamine. Suitable epoxies for this reaction may be produced by the attachment of an epoxide group to both ends of a paraffinic hydrocarbon chain (for example, diepoxides derived from butanediol) or of a polyether chain, such as α-ω-diepoxy polypropylene glycol. More exotic diepoxy resins suitable for said reaction include but are not limited to vinylcyclo hexene dioxide, 3,4-epoxycyclohexylmethyl 3,4-epoxycyclohexane monocarboxylate, 3-(3,4-epoxycyclo hexyl)-8,9-epoxy-2,4-dioxaspiro-[5.5]undecane, bis(2,3-epoxycyclopentyl) ether, bis(3,4-epoxy-6-methylcyclohexyl) adipate and resorcinol diglycidyl ether. Other suitable epoxy resins can contain more than two epoxide functional groups per molecule, such as epoxidized soya oils, polyglycidyl ethers of phenolic resins of the novolak type, p-aminophenoltriglycidyl ether or 1,1,2,2-tetra(p-hydroxyphenyl)ethane tetraglycidyl ether. Another class of epoxy resins suitable for use in said polymer composition comprises the epoxy polyethers obtained by reacting an epihalohydrin (such as epichlorohydrin or epibromohydrin) with a polyphenol in the presence of an alkali. Suitable polyphenols include resorcinol, catechol, hydroquinone, bis(4-hydroxyphenyl)-2,2-propane, i.e. bisphenol A; bis(4-hydroxyphenyl)-1,1-isobutane, 4,4-dihydroxybenzophenone; bis(4-hydroxyphenyl-1,1-ethane; bis(2-hydroxynaphenyl)-methane; bis(4-hydroxyphenyl)methane i.e. bisphenol F, and 1,5-hydroxynaphthalene. One very common polyepoxide is a polyglycidyl ether of a polyphenol, such as bisphenol A. Another class of suitable epoxy resin comprises the hydrogenated epoxy resin based on bisphenol A such as Eponex 1510 from Shell. Other examples of suitable epoxy resins are the polyglycidyl ethers of polyhydric alcohols. These compounds may be derived from such polyhydric alcohols as ethylene glycol, diethylene glycol, triethylene glycol, 1,2-propylene glycol, 1,4-butylene glycol, 1,5-pentanediol, 1,2,6-hexane-triol, glycerol, trimethylolpropane, and bis(4-hydroxycyclohexyl)-2,2-propane. A detailed list of suitable epoxide for said reaction can be found in the handbooks A. M. Paquin, “Epoxddverbindungen und Harze” (Epoxide Compounds and Resins), Springer Verlag, Berlin 1958, Chapter IV and H. Lee and K. Neville, “Handbook of Epoxy Resins” MC Graw Hill Book Company, New York 1982 Reissue, as well as C. A. May, “Epoxy Resins-Chemistry and Technology”, Marcel Dekker, Inc. New York and Basle, 1988.

Suitable epoxy for said reaction may also be selected from the glycidyl ester of branched carboxylic acids such as the glycidyl ester of pivalic or versatic acid containing 5 or 10 carbon atoms in the acid moiety, such as for example Cardura E5 or Cardura E10 from Resolution; non-aromatic diglycidyl ethers of cyclohexane dimethanol, bisphenol A diglycidyl ether such as Epikote 828, hydrogenated bisphenol A diglycidyl ether (DGEBA) type epoxy resins, such as Eponex 1510; aliphatic epoxy resins such as Araldite DY-C, DY-T and DY-0397 from Vantico; and bisphenol F diglycidyl ether type epoxy resin such as Epikote 862 from Resolution Performance Products and hydrogenated bisphenol F diglycidyl ether type epoxy resin such as Rütapox VE4261/R from Rutgers Bakelite.

Suitable polyamine include 1,2-diaminoethane, 1,2-diaminopropane, 1,3-diaminopropane, 1,4-diaminobutane and higher homologues, as well as 2-methyl-1,5-diaminopentane, 1,3-diaminopentane, 2,2,4-trimethyl-1,6-diaminohexane and 2,4,4-trimethyl-1,6-diaminohexane as well as industrial mixtures thereof, 1-amino-3-aminomethyl-3,5,5-trimethylcyclohexane, 2,2-dimethyl-1,3-diaminopropane, 1,3-bis(aminomethyl)cyclohexane, 1,2-diamino-cyclohexane, 1,3-bis(aminomethyl)benzene, bis(4-aminocyclohexyl)methane, bis(4-amino-3-methylcyclohexyl)methane, 3-azapentane-1,5-diamine, 4-azaheptane-1,7-diamine, 3,6-diazaoctane-1,8-diamine, benzyloxypropylaminepropylamine, diethylamino-propylamine, 3(4),8(9)-bis(aminomethyl)tricyclo-[5.2.1.0^{2,6}]decane, 3-methyl-3-azapentane-1,5-diamine, 3,6-dioxaoctane-1,8-diamine, 3,6,9-trioxaundecane-1,11-diamine, 4,7-dioxadecane-1,10-diamine, 4,7,10-trioxatridecane-1,13-diamine, 4-aminomethyl-1,8-diaminooctane, 2-butyl-2-ethyl-1,5-diaminopentane, 3-(aminomethyl)benzylamine (MXDA), 5-(amino-methyl)bicyclo[[2.2.1]hept-2-yl]methylamine (NBDA), polyamino imidazoline (Versamid 140™), as well as diethylenetriamine (DETA), triethylenetetramine (TETA, which is a mixture of several polyamines), pentaethylene-tetramine, dimethyidipropylene-triamine, dimethylaminopropyl-aminopropylamine (DMAPAPA), N-2-(aminoethyl)piperazine (N-AEP), N-(3-aminopropyl)piperazine, norbornane diamine, epilink MX, isophoronediamine (IPD), diaminodicyclohexylmethane (PACM), dimethyidiaminodicyclohexyl methane (Laromin C260™), tetramethylhexamethylenediamine (TMD), bis aminomethyl-dicyclopentadiene (tricyclodecyldiamine, TCD), diaminocyclohexane, diethylaminopropylamine (DEAPA), and the like. Suitable polyoxyalkylenepolyamines can be obtained, for example, under the trade name ®Jeffamine such as polyoxypropylene triamine (Jeffamine T403) and polyoxypropylene diamine (Jeffamine D230), and suitable polyiminoalkylenepolyamines are available, for example, under the trade name ®Polymin. In addition, mixtures from several amines are possible.

Primary aliphatic monoamines can also be added to the curing composition. Suitable monoamines include, for example, unbranched 1-aminoalkanes with for example a saturated alkyl radical of 6 to 22 carbon atoms. The higher representatives of this class of compounds also are called fatty amines. Non-limiting examples include laurylamine, stearylamine, palmitylamine and biphenylamine. However, monoamines with branched chains also are suitable, for example 2-ethylhexan-1-amine or 3,5,5-trimethylhexan-1-amine, amino-2-butane, methoxypropylamine, isopropoxypropylamine. They can be employed individually or as a mixture, and in particular in an amount ranging from 0.1 to 10%, and for example in an amount ranging from 1 to 5%.

The reaction between the polysiloxane of formula (2) and amino alcohol of formula (3) may also be performed in the presence of a suitable catalyst. Said catalyst may, for example, be an inorganic acid such as hydrochloric acid, nitric acid, sulfuric acid or phosphoric acid, an organic acid such as acetic acid, paratoluenesulfonic acid, formic acid or an alkaline catalyst such as potassium hydroxide, sodium hydroxide, calcium hydroxide or ammonia, an organic metal, a metal alkoxide, an organic tin compound such as dibutyltin dilaurate, dibutyltin dioctiate or dibutyltin diacetate, or a boron compound such as boron butoxide or boric acid. Illustrative examples of metal alkoxide include aluminum triethoxide, aluminum triisopropoxide, aluminum tributoxide, aluminum tri-sec-butoxide, aluminum diisopropoxy-sec-butoxide, aluminum diisopropoxyacetyl acetonate, aluminum di-sec-butoxyacetyl acetanoate, aluminum diisopropoxyethyl acetoacetate, aluminum di-sec-butoxyethylacetoacetate, aluminum trisacetyl acetonate, aluminum trisethylaceto acetate, aluminum acetylacetonate bisethylacetoacetate, titanium tetraethoxide, titanium tetraisopropoxide, titanium (IV) butoxide, titanium diisopropoxybisacetyl acetonate, titanium diisopropoxybisethyl acetoacetate, titanium tetra-2-ethylhexyloxide, titanium diisopropoxybis(2-ethyl-1,3-hexanediolate), titanium dibutoxybis(triethanolaminate), zirconium tetrabutoxide, zirconium tetraisopropoxide, zirconium tetramethoxide, zirconium tributoxide monoacetylacetonate, zirconium dibutoxide bisacetylacetonate, zirconium butoxide trisacetylacetonate, zirconium tetraacetylacetonate, zirconium tributoxide monoethylacetoacetate, zirconium dibutoxide bisethylacetoacetate, zirconium butoxide trisethylacetoacetate and zirconium tetraethylacetoacetate. In addition to these compounds, cyclic 1,3,5-triisopropoxycyclotrialuminoxane and the like can also be used. Among these compounds, aluminum trisopropoxide, aluminum tri-sec-butoxide, aluminum diisopropoxyethylacetoacetate, aluminum di-sec-butoxyethylacetoacetate, aluminum trisacetylacetonate, titanium tetraisopropoxide, titanium tetrabutoxide and zirconium tetrabutoxide are used preferably. According to an embodiment, the present invention relates to a method wherein the catalyst is titanium (IV) butoxide.

According to another aspect, the present invention relates to the use of an amino-functional polysiloxane according to the invention as a hardener.

According to another embodiment, the present invention also relates to the use of compounds selected from the group consisting of amino alkoxy silicon compounds and amino alkoxy siloxanes, as hardener. Examples of suitable alkoxy silicon compounds are described in U.S. Pat. No. 3,941,856 (column 2 to column 4 and example I, amino alkoxy compounds A to M), examples of suitable alkoxy siloxanes are described in EP 0 887 366, hereby incorporated by reference.

The present invention also relates to the use of an amino-functional polysiloxane as described above in a coating.

The present invention further relates to epoxy-polysiloxane compositions prepared, according to principles of this invention, by combining:(a) a base component comprising a polysiloxane of formula (4) as described above and an epoxy resin having more than one 1,2-epoxy groups per molecule with an epoxy equivalent weight in the range of from 100 to about 5,000; with (b) an aminopolysiloxane hardener componentas described above or a amino-functional polysiloxane of formula (1) according to the present invention; (c) optionally a catalyst; (d) optionally a pigment and/or filler component, and (e) optionally a second amino compound as an additional hardener.

In preparing epoxy-polysiloxane compositions of the present invention, the proportion of hardener component to resin component can vary over a wide range, regardless of whether the hardener is chosen from the general classes of amines, or from the general formulas (1) or (2′) above, or any combination thereof. In general, the epoxy resin component is cured with sufficient hardener to provide at least from about 0.5 to about 1.5 amine equivalent weight per 1 epoxy equivalent weight.

Examples of conventional amino-hardener suitable for use in said composition, include but are not limited to aliphatic, cycloaliphatic amine, aromatic, araliphatic amines, imidazoline group-containing polyaminoamides based on mono or polybasic acids, as well as adducts thereof. These compounds are part of the general state of the art and are described, inter alia, in Lee & Neville, “Handbook of Epoxy Resins”, MC Graw Hill Book Company, 1987, chapter 6-1 to 10-19. More in particular, useful amino-hardener which can be optionally added to the composition, include polyamines distinguished by the fact that they carry at least two primary amino groups, in each case bonded to an aliphatic carbon atom. It can also contain further secondary or tertiary amino groups. Suitable polyamines include polyaminoamides (from aliphatic diamines and aliphatic or aromatic dicarboxylic acids) and polyiminoalkylene-diamines and polyoxyethylene-polyamines, polyoxypropylene-polyamines and mixed polyoxyethylene/polyoxypropylene-polyamines, or amine adducts, such as amine-epoxy resin adducts. Said amines may contain 2 to 40 carbon atoms. For examples, the amines can be selected from polyoxyalkylene-polyamines and polyiminoalkylene-polyamines having 2 to 4 carbon atoms in the alkylene group, and have a number-average degree of polymerization of 2 to 100, other examples of amines can be linear, branched or cyclic aliphatic primary diaminoalkanes having 2 to 40 carbon atoms. In addition, said amines can be araliphatic amines having at least two primary amino groups, each of which are bonded to an aliphatic carbon atom.

In another embodiment, the present invention relates to a polymer composition comprising an amino-functional polysiloxane of formula (1) according to the invention, an epoxy resin, optionally a polysiloxane resin and optionally a catalyst. The polymer composition can include these amino-functional polysiloxanes in an amount ranging from 40 to 90% by weight (% of total weight of polymer: amino-functional polysiloxane+epoxy), or for example in an amount ranging from 40 to 80% by weight and for example in an amount ranging from 40 to 75% by weight.

More in particular, the polymer composition can include the amino-functional polysiloxane according to the invention in an amount ranging from 40 to 80% by weight and the epoxy resin in an amount ranging from 20 to 60% by weight.

With respect to the polysiloxane resin used to make up the base component, preferred polysiloxanes consist of those having the formula (4) as described above. It is preferred that R^{1′} and R² comprise groups having less than six carbon atoms to facilitate rapid hydrolysis of the polysiloxane, which reaction is driven by the volatility of the alcohol analog product of the hydrolysis.

Examples of suitable polysiloxane ingredients include but are not limited to polysiloxane of formula (2) as previously described including. Suitable alkoxy- and silanol-functional polysiloxanes are the same as that described above.

A preferred epoxy-polysiloxane composition comprises in the range of from 10 to 80% by weight polysiloxane. Using an amount of the polysiloxane ingredient outside of this range can produce a composition having inferior flexibility, weatherability and chemical resistance. A particularly preferred epoxy-polysiloxane composition comprises approximately 30% by weight polysiloxane.

The base component comprises a blend of epoxy resin and polysiloxane. Examples of suitable epoxy resins for the polymer composition are the same as those described above for the preparation of epoxy amine adducts. More in particular the epoxy resins suitable for said epoxy-polysiloxane composition are non-aromatic epoxy resins that contain more than one 1,2-epoxy groups per molecule. A preferred non-aromatic epoxy resin comprises two 1,2-epoxy groups per molecule. The epoxy resin is preferably in liquid rather than solid form, has an epoxy equivalent weight in the range of from about 100 to 5,000, and has a functionality of about two. In another embodiment, the epoxy resins suitable for said epoxy-polysiloxane composition are non-aromatic hydrogenated epoxy resins.

Suitable epoxy resins include but are not limited to non-aromatic diglycidyl ethers of cyclohexane dimethanol, bisphenol A diglycidyl ether, hydrogenated bisphenol A diglycidyl ether (DGEBA) type epoxy resins, such as Heloxy 107, Eponex 1510 and 1513 from Resolution performance products; Erisys GE-22, Epalloy 5000 and 5001 from CVC Specialty Chemicals; Polypox R11 from UPPC GmbH; Epo Tohto ST-1 000 and ST-3000 from Tohto Kasei; Epodil 757 from Air Products; and Araldite DY-C and DY-T from Vantico.

Other suitable non-aromatic epoxy resins include DER 732 and 736 from Dow Chemical; Heloxy 67, 68, 48, 84, 505 and 71 each from Resolution performance products; Erisys GE-20, GE-21, GE-23, GE-30, GE-31 and GE-60 from CVC Specialty Chemicals; Polypox R3, R14, R18, R19, R20 AND R21 from UPPC GmbH; aliphatic epoxy resins such as Araldite DY-T and DY-0397 from Vantico; ERL4221 from Union Carbide; and Aroflint 607 from Reichold Chemicals and bisphenol F diglycidyl ether type epoxy resin such as Epikote 862 from Resolution Performance Products and hydrogenated bisphenol F diglycidyl ether type epoxy resin such as Rütapox VE4261/R from Rutgers Bakelite.

A preferred epoxy-polysiloxane composition comprises in the range of from 10 to 50% by weight epoxy resin. If the composition comprises less than about 10% by weight epoxy resin, chemical resistance of the coating will be compromised. If the composition comprises greater than about 50% by weight epoxy resin, the weatherability of the coating will be compromised. A particularly preferred composition comprises approximately 20% by weight epoxy resin.

If appropriate, the polymer composition according to the invention may additionally comprise a diluent which is inert. Examples of suitable diluents include aliphatic linear, branched or cyclic ethers having 4 to 20 carbon atoms and mixed aliphatic-aromatic ethers having 7 to 20 carbon atoms, such as dibenzyl ether, tetrahydrofuran, 1,2-dimethoxyethane or methoxybenzene; aliphatic linear, branched or cyclic or mixed aliphatic-aromatic ketones having 4 to 20 carbon atoms, such as butanone, cyclohexanone, methyl isobutyl ketone or acetophenone; aliphatic linear, branched or cyclic or mixed aromatic-aliphatic alcohols having 4 to 20 carbon atoms, such as methanol, ethanol, butanol, 2-propanol, isobutanol, isopropanol, benzyl alcohol, methoxypropanol or furfuryl alcohol; aliphatic linear, branched or cyclic or mixed aromatic-aliphatic esters such as methoxypropylacetate, ethoxypropylacetate or DBE (dibasic esters from Dupont, mixture of dimethyl adipate, succinate and glutarate); aliphatic linear, branched or cyclic or mixed aromatic-aliphatic hydrocarbons such as toluene, xylene, heptane and mixtures of aliphatic and aromatic hydrocarbons having a boiling range above 80° C. under normal pressure, as well as low-viscosity coumarone-indene resins, styrenated phenolic resins or xylene-formaldehyde resins. Aliphatic alcohols having one phenyl radical, such as benzyl alcohol, 1-phenoxypropane-2,3-diol, 3-phenyl-1-propanol, 2-phenoxy-1-ethanol, 1-phenoxy-2-propanol, 2-phenoxy-1-propanol, 2-phenylethanol, 1-phenyl-1-ethanol or 2-phenyl-1-propanol, are preferred. The diluents can be employed individually or as a mixture, and in particular in a amount ranging from 1 to 35% by weight, for example in an amount ranging from 5 to 25% by weight and for example in an amount ranging from 10 to 30%.

The polymer composition may also contain other components to achieve the desired properties sought by the user, such as, auxiliaries or additives such as pigments or filler ingredients, solvents, colorants, mineral oils, fillers, elastomers, antioxidants, stabilizers, defoamers, extenders, rheological modifiers, plasticizers, thixotropic agents, adhesion promoters, catalysts, pigment pastes, reinforcing agents, flow control agents, thickening agents, flame-retarding agents, additional hardeners and additional curable compounds, depending on the application.

Epoxy-polysiloxane compositions of this invention are formulated for application with conventional air, airless, air-assisted airless and electrostatic spray equipment, brush, or roller. The compositions can be used as protective coatings for steel, galvanized steel, aluminum, concrete and other substrates at dry film thickness in the range of from about 50 μm to about 500 μm.

Suitable pigments may be selected from organic and inorganic color pigments which may include titanium dioxide, carbon black, lampblack, zinc oxide, natural and synthetic red, yellow, brown and black iron oxides, toluidine and benzidine yellow, phthalocyanine blue and green, and carbazole violet, and extender pigments including ground and crystalline silica, barium sulfate, magnesium silicate, calcium silicate, mica, micaceous iron oxide, calcium carbonate, zinc powder, aluminum and aluminum silicate, gypsum, feldspar and the like. The amount of pigment that is used to form the composition is understood to vary, depending on the particular composition application, and can be zero when a clear composition is desired. For example a polymer composition may comprise up to 50% by weight fine particle size pigment and/or filler. Depending on the particular end use, a preferred composition may comprise approximately 25% by weight fine particle size filler and/or pigment.

More in particular said pigment or filler material having a fine particle size selected from the group comprising organic and inorganic pigments, wherein at least 90% by weight of the pigment is being smaller than 40 microns particle size.

The pigment and/or filler ingredient is typically added to the epoxy resin portion of the resin component and is dispersed with a highspeed dissolver mixer to at least 50 μm fineness of grind, or alternatively is ball milled or sand milled to the same fineness of grind. Selection of a fine particle size pigment or filler and dispersion or milling to about 50 μm grind allows for the atomization of mixed resin and cure components with conventional air, air-assisted airless, airless and electrostatic spray equipment, and provides a smooth, uniform surface appearance after application.

Additional water may be present in a sufficient amount to bring about both the hydrolysis of the polysiloxane and the subsequent condensation of the formed silanols.

Additional water may be added to accelerate cure of said polymer composition depending on ambient conditions such as the use of the coating composition in arid environments. The sources of water are mainly atmospheric humidity and adsorbed moisture on the pigment or filler material. Other sources of water may include trace amounts present in the epoxy resin, the hardener, thinning solvent, or other ingredients that could be added to said composition.

For example, the epoxy-polysiloxane composition may comprise up to a stoichiometric amount of water to facilitate hydrolysis. If desired, water may be added to either the epoxy resin or the hardener. Regardless of its source, the total amount of water if present should be the stoichiometric amount needed to facilitate the hydrolysis reaction. Water exceeding the stoichiometric amount is undesirable since excess water acts to reduce the surface gloss of the finally-cured composition product.

Up to about 5% by weight catalyst may be added to the resin component, or may be added as an entirely separate component, to speed drying and curing of the epoxy-polysiloxane compositions of the present invention. Useful catalysts include metal driers well known in the paint industry, e.g. zinc, manganese, zirconium, titanium, cobalt, iron, lead and tin containing driers. Suitable catalysts include organotin catalysts having the general formula (8): 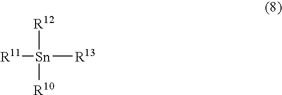
wherein R¹³ and R¹⁰ are each independently selected from the group comprising alkyl, aryl, and alkoxy radicals having up to eleven carbon atoms, and wherein R¹¹ and R¹² are each independently selected from the same groups as R¹³ and R¹⁰, or from the group comprising inorganic atoms such as halogens, sulphur or oxygen. Dibutyl tin dilaurate, dibutyl tin diacetate, organotitanates, sodium acetate, and aliphatic secondary or tertiary polyamines including propylamine, ethylamino ethanol, trethanolamine, triethylamine, and methyl diethanol amine may be used alone or in combination to accelerate hydrolytic polycondensation of polysiloxane. A preferred catalyst is dibutyl tin dilaurate.

Other suitable catalysts include acids such as organic acids, inorganic acids, organic sulfonic acids, esters of sulfuric acid and superacids. Organic acids include acetic acid, formic acid and the like. Inorganic acids include sulfuric acid, hydrochloric acid, perchloric acid, nitric acid, phosphoric acid, and the like. Organic sulfonic acids include both aromatic and aliphatic sulfonic acids. Representative sulfonic acids that are commercially available include methanesulfonic, trifluoromethanesulfonic, benzenesulfonic, dodecylbenzenesulfonic, dodecyidiphenyloxide sulfonic, 5-methyl-1-naphthylenesulfonic, and p-toluenesulfonic acid, sulfonated polystyrene, and the sulfonates derived from polytetrafluoroethylenes. Superacids suitable as catalysts are described in G. A. Olah, G. K. S. Prakash, and J. Sommer, Superacids, John Wiley & Sons: New York, 1985. Useful superacids include perchloric, fluorosulfuric, trifluoromethanesulfonic, and perfluoroalkylsulfonic acids. They also include Lewis superacids such as SbF₅, TaF₅, NbF₅, PF₅, and BF₃. Superacids also include hydrogen fluoride in combination with fluorinated Lewis acids such as SbF₅, TaF₅, NbF₅, PF₆, and BF₃. They also include oxygenated Bronsted acids such as sulfuric, fluorosulfuric, trifluoromethanesulfonic, and perfluoroalkylsulfonic acid in combination with Lewis acids such as SbF₅, TaF₅, NbF₅, PF₅, and BF₃.

Other examples of suitable catalysts include nitrate of a polyvalent metal ion such as calcium nitrate, magnesium nitrate, aluminum nitrate, zinc nitrate, or strontium nitrate.

Epoxy-polysiloxane compositions of the present invention are generally low in viscosity and can be spray applied without the addition of a solvent. However, organic solvents may be added to improve atomization and application with electrostatic spray equipment or to improve flow and leveling and appearance when applied by brush, roller, or standard air and airless spray equipment. Exemplary solvents useful for this purpose include aromatic hydrocarbons, esters, ethers, alcohols, ketones, glycols and the like. The amount of solvent added to compositions of the present invention preferably is less than 250 grams per liter and more preferably less than about 120 grams per liter.

Epoxy-polysiloxane compositions of the present invention may also contain rheological modifiers, plasticizers, antifoam agents, thixotropic agents, adhesion promoters, pigment wetting agents, anti-settling agents, diluents, UV light stabilizers, air release agents and dispersing aids. A preferred epoxy-polysiloxane composition may comprise up to about 10% by weight such modifiers and agents.

Epoxy-polysiloxane compositions of the present invention can be supplied as a two-package system in moisture proof containers. One package contains the epoxy resin, polysiloxane, any pigment and/or filler ingredient, optionally catalysts, additives and solvent if desired. The second package contains an aminopolysiloxane optionally a second amine compound as an additional hardener and optionally catalysts, solvents and additives.

Epoxy-polysiloxane compositions of the present invention can be applied and fully cure at ambient temperature conditions in the range of from about −10° C. to 50° C. At temperatures below 0° C. absence of water has a strong influence on the curing speed and also on the final properties of the coating. Curing of said polymer composition according to the invention typically can proceed very rapidly, and in general can take place at a temperature within the range of from −10° C. to +50° C., in particular from 0° C. to 40° C., more in particular from 3 to 25° C. However, compositions of the present invention may be cured by additional heating.

The present invention further relates to a method for the preparation of a polymer composition as described above, comprising the step of mixing an amino-functional polysiloxane according to the invention, with an epoxy resin, optionally a polysiloxane resin and optionally a catalyst.

More in particular the present invention relates to methods for the preparation of epoxy-polysiloxane compositions according to the invention, comprising the steps of combining: a polysiloxane of formula (4) as described above with an epoxy resin having more than one 1,2-epoxy groups per molecule with an epoxy equivalent weight in the range of from 100 to about 5,000; a sufficient amount of an aminopolysiloxane hardener component or an amino-functional polysiloxane of formula (1) having active hydrogens, preferably at least two active hydrogens; an optional catalyst; and a sufficient amount of water to facilitate hydrolysis and polycondensation reactions to form the fully-cured cross-linked epoxy-polysiloxane polymer composition at ambient temperature. Preferably, the aminopolysiloxane hardener provides in the range of from 0.5 to 1.5 amine equivalent weight per one epoxy equivalent weight. According to an embodiment said polysiloxane is selected from the group comprising alkoxy- and silanol-functional polysiloxanes having a molecular weight in the range of from about 400 to 10,000.

Examples of suitable catalysts for said method are described above. Up to 10% by weight catalyst may be added to the polymer composition, or may be added as an entirely separate component, to speed drying and curing of the polymer composition. As described above useful catalysts include metal driers well known in the paint industry, e.g. zinc, manganese, zirconium, titanium, cobalt, iron, lead and tin containing driers. Suitable catalysts include organotin catalysts. For example, dibutyl tin dilaurate, dibutyl tin diacetate, organotitanates, sodium acetate, and aliphatic secondary or tertiary polyamines including propylamine, ethylamino ethanol, triethanolamine, triethylamine, and methyl diethanol amine may be used alone or in combination.

The present invention further relates to an epoxy-polysiloxane polymer composition obtainable by combining: a sufficient amount of an amino-functional polysiloxane of formula (1) as described above as a hardener with a polysiloxane of formula (4) as previously described, and an epoxy resin having more than 1,2 epoxy groups per molecule with an epoxy equivalent weight ranging from 100 to 5000.

Examples of suitable epoxy resins for the epoxy-polysiloxane polymer composition are the same as that described above. Preferred epoxy resins include non-aromatic diglycidyl ethers of cyclohexane dimethanol, bisphenol A diglycidyl ether, hydrogenated bisphenol A diglycidyl ether (DGEBA) type epoxy resins, such as Heloxy 107, Eponex 1510 and 1513 from Resolution Performance Products; Erisys GE-22, Epalloy 5000 and 5001 from CVC Specialty Chemicals; Polypox R11 from UPPC GmbH; Epo Tohto ST-1000 and ST-3000 from Tohto Kasei; Epodil 757 from Air Products; and Araldite DY-C from Vantico. Other suitable non-aromatic epoxy resins include DER 732 and 736 from Dow Chemical; Heloxy 67, 68, 48, 84, 505 and 71 each from Resolution Performance Products; Erisys GE-20, GE-21, GE-23, GE-30, GE-31 and GE-60 from CVC Specialty Chemicals; Polypox R3, R14, R18, R19, R20 AND R21 from UPPC GmbH; Araldite DY-C, DY-T and DY-0397 from Vantico; ERL4221 from Union Carbide; and Aroflint 607 from Reichold Chemicals and bisphenol F diglycidyl ether type epoxy resin such as Epikote 862 from Resolution Performance Products and hydrogenated bisphenol F diglycidyl ether type epoxy resin such as Rütapox VE4261/R from Rutgers Bakelite.

Examples of suitable polysiloxanes formula (4) have been described above. Other examples of suitable polysiloxane include the polysiloxane of formula (2) as described above. The polymer composition may also contain some unmodified polysiloxane.

The epoxy-polysiloxane composition may also contain auxiliaries or additives such as pigments or filler ingredients, solvents, colorants, mineral oils, fillers, elastomers, antioxidants, stabilizers, defoamers, extenders, rheological modifiers, plasticizers, thixotropic agents, adhesion promoters, catalysts, pigment pastes, reinforcing agents, flow control agents, thickening agents, flame-retarding agents, additional hardeners and additional curable compounds, depending on the application.

The present invention further encompasses a substrate provided with at least one layer of a cured network of epoxy-polysiloxane polymer composition according to the invention.

The present invention further relates to a method for making a fully-cured thermosetting epoxy-polysiloxane composition according to the invention comprising the steps of:
forming a base component by combining: an epoxy resin as described above; a polysiloxane of formula (4) as described above; and
curing the base component at ambient temperature by adding thereto: an aminopolysiloxane or an amino-functional polysiloxane of formula (1) with active hydrogens, preferably at least two active hydrogens, able to react with epoxy groups in the epoxy resin to form polymers containing hydroxyl groups, which are able to react with the silanol groups of hydrolyzed polysiloxane to form a polymer network, wherein the epoxy chain polymers and polysiloxane polymers polymerize to form a fully-cured epoxy-polysiloxane polymer composition and optionally a catalyst to facilitate curing the base component at ambient temperature.

In another embodiment, said polysiloxane is selected from the group comprising alkoxy- and silanol-functional polysiloxanes having a molecular weight in the range of from 400 to 10,000.

While not wishing to be bound by any particular theory, it is believed that epoxy-polysiloxane compositions of the present invention may be cured by: (i) the reaction of the epoxy resin with the aminopolysiloxane of formula (1) and/or a second amine compound to form epoxy polymer chains; (ii) the hydrolytic polycondensation of the polysiloxane ingredient to produce alcohol and polysiloxane polymer; and (iii) the copolymerization of the epoxy polymer chains with the polysiloxane polymer. This copolymerization reaction is believed to take place via the condensation reaction of silanol groups of hydrolyzed polysiloxane (polymer) with silanol and hydroxyl groups in the epoxy polymer chains. Eventually a fully-cured epoxy-polysiloxane polymer composition is formed. The amine moiety of the aminopolysiloxane and the optional second amine compound as an additional hardener undergoes the epoxy-amine addition reaction and the silane moiety of the aminopolysiloxane undergoes hydrolytic polycondensation with the polysiloxane. In its cured form, the epoxy-polysiloxane composition exists as a uniformly dispersed arrangement of a continuous polysiloxane polymer matrix intertwined with epoxy polymer chain fragments that are cross-linked with the polysiloxane polymer matrix, thereby forming a polymer network that has substantial advantages over conventional polysiloxane systems.

Epoxy-polysiloxane compositions of the present invention exhibit an unexpected and surprising improvement in gloss retention. Moreover, the polymer composition of the present invention also shows an unexpected and surprising improvement in hardness development. Moreover the compositions according to the invention have improved mechanical cohesive strength and a high degree of flexibility which makes it possible to apply this class of coatings on complex steel structures with very limited risk of cracking.

The compositions according to the invention are compatible with suitable dispenser tinting systems, and permit the supply of large variety of color easily.

Pigmentation of these compositions may be generally done with normal light fast paint pigments, and for specific conditions, glass-flake addition can be considered to further reduce water permeation and to extend service life.

The compositions according to the invention can find various industrial applications because of their favorable properties such as along pot life in combination with reasonably fast curing time, rapid drying, even at low temperatures and even under high atmospheric humidity. Typical industrial applications for said compositions include, for example, use for the production of shaped articles (casting resins) for tool construction, or for the production of coatings and/or intermediate coatings on many types of substrates, for example, on those of an organic or inorganic nature, such as textiles of natural or synthetic origin, plastics, glass, ceramic and building materials, such as concrete, fiberboards and artificial stones, but in particular on metals, such as optionally pretreated sheet steel, cast iron, aluminum and nonferrous metals, such as brass, bronze and copper. The compositions according to the invention can furthermore be employed as constituents of adhesives, putties, laminating resins and synthetic resin cements, and in particular as constituents of paints and coatings for coating industrial objects, domestic appliances and furniture and in the shipbuilding industry, land storage tanks and pipelines and in the building industry, such as, for example, refrigerators, washing machines, electrical appliances, windows and doors.

These coatings can be applied, for example, by brushing, spraying, rolling, dipping and the like. A particularly preferred field of use for the coatings according to the invention is paint formulations.

These and other features of the present invention will become more apparent upon consideration of the following examples and figures. Although epoxy-polysiloxane compositions of the present invention have been described with considerable detail with reference to certain preferred variations thereof, other variations are possible. Therefore, the spirit and scope of the appended claims should not be limited to the preferred variations described herein.

### BRIEF DESCRIPTION OF THE FIGURES

FIGS. 1, 2 and 3 represent graphs illustrating the gloss retention profiles of coatings according to the invention and comparative examples.

### EXAMPLES

Examples 1 to 13 describe the preparation of amino-functional polysiloxane according to the invention. In order to prepare said amino-functional polysiloxane, polysiloxane of formula (2) were reacted with different amino-alcohols.

The total amine value of the synthesized amino-functional polysiloxanes was determined according to method ASTM D2073-92

The low shear viscosity was measured with a Haake VT500 viscosimeter using a cylindrically-shaped E30 spindle at 23° C.

The molecular weight distribution was determined by Gel Permeation Chromatography (GPC apparatus from Millipore) using THF as solvent, 3 columns of Plgel 5 mm, mixed-D from Polymer Laboratories, calibration curves with commercial polystyrene standards.

Unless specified, the aminoalcohols used were purchased from Acros Organics or Aldrich.

### Example 1

140 g of ethanolamine and 1110 g of polysiloxane resin Silres SY231 (Wacker) are mixed in a reaction vessel under nitrogen atmosphere equipped with a mechanical stirrer, a distilling column and a condenser. Titanium (IV) butoxide is added. The mixture is then heated at 170° C. until all alcohols are distilled. The last volatile alcohols formed during reaction are then removed by applying vacuum. The modified polysiloxane has a MW of 1061 and a polydispersity of 4.99 (determined by GPC). NMR analysis showed that 0.6% of ethanolamine is free and the concentration of the MeO groups is 10.3%, the butoxy group is 5.5% and the bonded aminoethyl group is 16.6%. The amino value is 106.3 mg KOH/g.

### Example 2

129 g of 1-amino-2-propanol and 832 g of polysiloxane resin DC3074 (Dow Corning) are mixed in a reaction vessel under nitrogen atmosphere equipped with a mechanical stirrer, a distilling column and a condenser. The mixture is then heated at 160° C. until all alcohols are distilled. The last volatile alcohols formed during reaction are then removed by applying vacuum. The modified polysiloxane has a MW of 1006 and a polydispersity of 7.45 (determined by GPC). NMR analysis showed that 2.3% of 1-amino-2-propanol is free and the concentration of the MeO groups is 26.0% and the bonded 1-amino-2-propyl groups is 13.7%. The amino value is 105 mg KOH/g.

### Example 3

153 g of 2-amino-1-butanol and 832 g of polysiloxane resin DC3074 (Dow Corning) are mixed in a reaction vessel under nitrogen atmosphere equipped with a mechanical stirrer, a distilling column and a condenser. 45 g of Heptane and 1 g of titanium (IV) butoxide are added. The mixture is then heated at 175° C. until all azeotrope mixture is distilled off. The last volatile alcohols formed during reaction are then removed by applying vacuum. The modified polysiloxane has a MW of 1123 and a polydispersity of 3.16 (determined by GPC). NMR analysis showed that 3% of 2-amino-1-butanol is free and the concentration of the MeO groups is 25.0% and the bonded 2-amino-1-butyl groups is 14.8%. The viscosity (Haake, 23° C.) is 6.5 dpa.s. The amino value is 103.8 mg KOH/g.

### Example 4

306 g of 2-amino-1-butanol and 832 g of polysiloxane resin DC3074 (Dow Corning) are mixed in a reaction vessel under nitrogen atmosphere equipped with a mechanical stirrer, a distilling column and a condenser. 120 g of heptane and 1 g of titanium (IV) butoxide are added. The mixture is then heated at 175° C. until all azeotrope mixture is distilled off. The last volatile alcohols formed during reaction are then removed by applying vacuum. The modified polysiloxane has a MW of 843 and a polydispersity of 4.08 (determined by GPC). The amino value is 200 mg KOH/g. The Haake viscosity is 13 dPa.s at 23° C. The density at 20° C. is 1.132 g/l.

### Example 5

129 g of 3-amino-1-propanol and 832 g of polysiloxane resin DC3074 (Dow Corning) are mixed in a reaction vessel under nitrogen atmosphere equipped with a mechanical stirrer, a distilling column and a condenser. The mixture is then heated at 190° C. until all alcohols are distilled. The last volatile alcohols formed during reaction are then removed by applying vacuum. The modified polysiloxane has a MW of 1283 and a polydispersity of 3.72 (determined by GPC). NMR analysis showed that 2.5% of 3-amino-1-propanol is free and the concentration of the MeO groups is 24.4% and the bonded 3-amino-1-propyl groups is 14.9%. The amino value is 106 mg KOH/g.

### Example 6

305 g of aminoethanol and 1110 g of polysiloxane resin Silres SY231 (Wacker) are mixed in a reaction vessel under nitrogen atmosphere equipped with a mechanical stirrer, a distilling column and a condenser. The mixture is then heated at 130° C. until all alcohols are distilled. The last volatile alcohols formed during reaction are then removed by applying vacuum. The amino value is 163.7 mg KOH/g and the viscosity (Haake, 23° C.) is 27 dPa.s. The density is 1.168 g/l at 20° C.

### Example 7

153 g of 2-amino-1-butanol and 832 g of polysiloxane resin Silres SY231 (Wacker) are mixed in a reaction vessel under nitrogen atmosphere equipped with a mechanical stirrer, a distilling column and a condenser. The mixture is then heated at 175° C. until all alcohols are distilled. During reaction, 1 g of titanium (IV) butoxide is added. The last volatile alcohols formed during reaction are then removed by applying vacuum. The amino value is 92 mg KOH/g and the viscosity (Haake, 23° C.) is 29 dPa.s.

### Example 8

153 g of 2-amino-1-butanol and 832 g of polysiloxane resin DC3074 (Dow Corning) are mixed in a reaction vessel under nitrogen atmosphere equipped with a mechanical stirrer, a distilling column and a condenser. The mixture is then heated at 175° C. until all alcohols are distilled. The last volatile alcohols formed during reaction are then removed by applying vacuum. The modified polysiloxane has a MW of 946 and a polydispersity of 32.2 (determined by GPC). The amino value is 97 mg KOH/g and the viscosity (Haake, 23° C.) is 5 dPa.s.

### Example 9

a) epoxy-adduct between norbornane diamine and glycidylester of versatic acid:

154.4 g of norbornane diamine (from Degussa) and 250 g of Cardura E10 (from Resolution) are mixed in a reaction vessel under nitrogen atmosphere equipped with a mechanical stirrer, a distilling column and a condenser. The mixture is then heated at 60° C. during one hour, then at 100° C. for two hours. The modified amine has an amino value of 261 mg KOH/g.

b) reaction of 9a) with polysiloxane:

210 g of aminoalcohol from example 9a) and 111 g of polysiloxane resin DC3074 (Dow Corning) are mixed in a reaction vessel under nitrogen atmosphere equipped with a mechanical stirrer, a distilling column and a condenser. 100 g of heptane are added to the mixture. The mixture is then heated at 175° C. until all azeotrope is distilled. The last volatile alcohols formed during reaction are then removed by applying vacuum. The modified polysiloxane has a MW of 2060 and a polydispersity of 12.7 (determined by GPC). The amine value is 154 mg KOH/g and the viscosity (Haake, 23° C.) is 20 dpa.s.

### Example 10

10a) epoxy-adduct between isophoronediamine and glycidylester of versatic acid:

170 g of isophoronediamine (Vestamin IPD from Degussa) and 250 g of Cardura E10 (from Resolution) are mixed in a reaction vessel under nitrogen atmosphere equipped with a mechanical stirrer, a distilling column and a condenser. The mixture is then heated at 100° C. for two hours. The modified aminoalcohol has an amine value of 265 mg KOH/g.

10b) reaction of 10a) with polysiloxane

210 g of aminoalcohol from example 10a and 111 g of polysiloxane resin DC3074 (Dow Corning) are mixed in a reaction vessel under nitrogen atmosphere equipped with a mechanical stirrer, a distilling column and a condenser. 100 g of heptane are added to the mixture. The mixture is then heated at 175° C. until all azeotrope is distilled. The last volatile alcohols formed during reaction are then removed by applying vacuum. 60 g of xylene are added. The modified polysiloxane has a MW of 2060 and a polydispersity of 12.7 (determined by GPC). The amine value is 151 mg KOH/g and the viscosity (Haake, 23° C.) is 72 dPa.s.

### Example 11

194.8 g of 2-(2-aminoethylamino)ethanol and 830 g of polysiloxane resin Silres SY231 (Wacker) are mixed in a reaction vessel under nitrogen atmosphere equipped with a mechanical stirrer, a distilling column and a condenser. 120 g of heptane are added to the mixture. The mixture is then heated at 175° C. until all azeotrope is distilled. The last volatile alcohols formed during reaction are then removed by applying vacuum. The amine value is 201 mg KOH/g and the viscosity (Haake, 23° C.) is 9 dPa.s.

### Example 12

200.6 g of 2-(2-aminoethoxy)ethanol and 830 g of polysiloxane resin Silres SY231 (Wacker) are mixed in a reaction vessel under nitrogen atmosphere equipped with a mechanical stirrer, a distilling column and a condenser. 120 g of heptane are added to the mixture. The mixture is then heated at 175° C. until all azeotrope is distilled. The last volatile alcohols formed during reaction are then removed by applying vacuum. The amine value is 201 mg KOH/g and the viscosity (Haake, 23° C.) is 7 dpa.s.

### Example 13

369.1 g of 2-(2-aminoethoxy)ethanol and 830 g of polysiloxane resin Silres SY231 (Wacker) are mixed in a reaction vessel under nitrogen atmosphere equipped with a mechanical stirrer, a distilling column and a condenser. 120 g of heptane are added to the mixture. The mixture is then heated at 175° C. until all azeotrope is distilled. The last volatile alcohols formed during reaction are then removed by applying vacuum. The amine value is 345 mg KOH/g and the viscosity (Haake, 23° C.) is 6 dpa.s.

### Example 14

### Clear Coatings According to the Invention

This example describes the preparation of polymers according to the invention comprising amino-functional polysiloxane according to the invention and an epoxy resin. These polymers were formulated as clear films, and the Koenig hardness was measured. The reference example was prepared by mixing an epoxy resin with a commercial aminopolysiloxane bought from Wacker under the name of Silres 44100 VP, having Si—C bonded amine groups and an amine value of 227 mg KOH/g (AHEW 247 g/eq.). The comparative example was prepared by mixing an epoxy resin with Jeffamine T403 (Huntsman).

5 g of Eponex 1510 (Resolution Performance Products) were mixed with the following polysiloxanes at a 1/1 stoichiometry. Drawdowns on glass were performed using a bird applicator BA30.

The Koenig hardness (ISO1522 and DIN53157) is a pendulum-damping test for assessment of the hardness of a coating. A pendulum of particular shape and time of oscillation rests on two balls on the paint film and is set into motion from a certain starting deflection angle (from 6° to 3°). The time in which the pendulum has arrived at a certain final angle is a measurement for the hardness of the paint film. The harder the coated surface, the higher the number of oscillations. The number of oscillations is then converted in seconds.

The Koenig hardness was measured after 1, 2, 5 13 and 21 days at room temperature. The results are shown in Table A.

TABLE A

| | | Koenig | Koenig | Koenig | Koenig | Koenig |
|---|---|---|---|---|---|---|
| | g/5 g | hardness (s) | hardness (s) | hardness (s) | hardness (s) | hardness (s) |
| Example | epoxy resin | 1 day | 2 days | 5 days | 13 days | 21 days |
| Reference | 5.51 | 90 | 157 | 176 | 203 | 195 |
| Example 1 | 11.81 | 48 | 113 | 138 | 160 | 178 |
| Example5 | 12.92 | 69 | 111 | 120 | 120 | 124 |
| Example2 | 12.92 | 71 | 167 | 200 | 212 | 196 |
| Example8 | 12.92 | not dry | 22 | 110 | 183 | 195 |
| Example4 | 6.27 | not dry | 48 | 133 | 179 | 202 |
| Comparative | 1.81 | not dry | not dry | not dry | sticky | sticky |
| example | | | | | | |
| Example12 | 8.31 | not dry | 11 | 67 | 154 | 195 |

The films comprising amino-functional polysiloxanes according to the present invention exhibit a dried film after one or two days, whereas a film comprising a conventional amine (comparative example) does not dry efficiently. The hardness development obtained can be moderate to very high, depending on the requirements of the paint formulation.

### Example 15

### Coatings

This example describes the preparation of epoxy-polysiloxane coatings according to the invention comprising amino-functional polysiloxane according to the invention as a hardener, a polysiloxane and an epoxy resin. In the coatings tested in this example, a white base epoxy paint (Base) used is shown in Table B. The Base has an Epoxy Equivalent in Weight of (EEW) 835.6 g/eq. The Koenig hardness and the appearance of the coatings were measured. Coating III was prepared by mixing the white Base with a commercial aminopolysiloxane bought from Wacker under the name of Silres 44100 VP, having Si—C bonded amine groups and an amine value of 227 mg KOH/g (AHEW 247 g/eq.) (denoted hereunder as reference).

TABLE B

| Ingredients Base | Weight In g |
|---|---|
| Hydrogenated bisphenol A epoxy resin | 25 |
| Thixotropic agent | 0.5 |
| Defoamer | 0.65 |
| Pigment, charges | 35.2 |
| Polysiloxane resin, DC 3074 | 35 |
| Catalyst | 2 |
| Solvent | 3 |

Drawdowns were performed with BA 30 on glass panels. The stoichiometric ratio was 100%. The quantities (in g) and the results are shown Table C.

TABLE C

| | Coatings | | |
|---|---|---|---|
| | I | II | III |
| Base | 20 | 20 | 20 |
| Example 7 | 14.6 | — | — |
| Example 8 | — | 13.8 | — |
| Reference | — | — | 5.9 |
| Appearance | glossy, smooth, | glossy, smooth | glossy |
| | yellowing | | |
| Gloss [H20/H60/H85] | 84/94/97 | 80/91/96 | 70/91/94 |

Coatings I-III have high gloss. The flow of coatings I-III is very good and the films look very smooth.

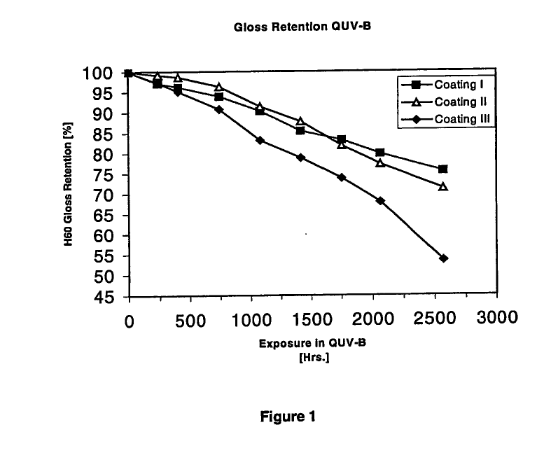

Next, the coatings were tested in accelerated weathering according to ASTM G53, in QUV-B: these tests were designed to simulate accelerated weathering conditions caused by sunlight. Test panels are exposed to alternating ultraviolet and humidity cycles. They are checked periodically and degradation is measured by loss of gloss. The results are shown in FIG. 1. From these results, it can be seen that the coating compositions according to the present invention have a better gloss retention and UV resistance than the commercial references.

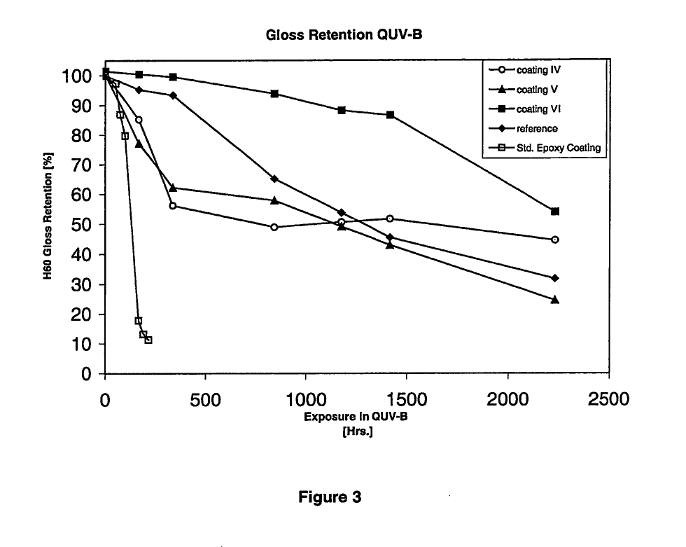

Next, the hardness development was measured for coatings IV, V, VI (Table D). Drawdowns were performed with BA 30 on glass panels. The stoichiometric ratio was 100%. The quantities (in g) and the results are shown in Table D and on FIG. 3, the panels were sprayed at 200-250 μm (wet) and were left to dry for 2 weeks at room temperature.

TABLE D

| | | | | | Koenig hardness [sec.] | | |
|---|---|---|---|---|---|---|---|
| Coatings | Base | Aminopolysiloxane | Xylene | Viscosity, dPa · s | 4 days | 7 days | 12 days |
| Coating IV | 250 | 111.2 of example 10 | 8 | 9.3 | 52 | 70 | 94 |
| Coating V | 250 | 108.8 of example 9 | / | 8.6 | 73 | 77 | 87 |
| Coating VI | 250 | 156.7 of example 2 | / | 8.2 | 111 | 122 | 127 |
| Reference | 250 | 73.7 | / | 9.0 | 108 | 116 | 126 |

Hardness measurements and gloss retention in QUV accelerated weathering tests clearly show that coatings formed from epoxy-polysiloxane polymer compositions according to the invention have improved gloss retention, weathering resistance with similar to identical hardness development when compared to conventional epoxy-based coating compositions.

### Example 16

### Coatings

Coating 1 is a comparative example. It is a conventional coating composition comprising bisphenol A epoxy resin 75 wt % solution in xylene with an epoxy equivalent weight of 610-640 g/eq and as a hardener, a commercial aminopolysiloxane bought from Wacker under the name Silres 44100 VP, having Si—C bonded amine groups and an amine value of 227 mg KOH/g (AHEW 247 g/eq.).

Coating 2 is an epoxy-polysiloxane according to the invention comprising a polysiloxane DC 3074, bisphenol A epoxy resin 75 wt % solution in xylene with an epoxy equivalent weight of 610-640 g/eq and as a hardener, a commercial aminopolysiloxane bought from Wacker under the name Silres 44100 VP, having Si—C bonded amine groups and an amine value of 227 mg KOH/g (AHEW 247 g/eq.).

Coating 3 is a comparative example. It is a commercial coating from Ameron, sold under the name of Ameron PSX 700 comprising a polysiloxane, hydrogenated bisphenol A epoxy resin with an epoxy equivalent weight of 210-238 g/eq and an amino-silane as a hardener (PSX 700 Cure from Ameron).

Coating 4 is an epoxy-polysiloxane composition according to the invention, comprising a polysiloxane DC 3074, a hydrogenated bisphenol A epoxy resin with an epoxy equivalent weight of 210-238 g/eq, and as a hardener, a commercial aminopolysiloxane bought from Wacker under the name Silres 44100 VP, having Si—C bonded amine groups and an amine value of 227 mg KOH/g (AHEW 247 g/eq.).

Coating 5 is an epoxy-polysiloxane composition according to the invention, comprising a polysiloxane DC3074 (Dow Corning), hydrogenated bisphenol A epoxy resin with an epoxy equivalent weight of 210-238 g/eq and the aminopolysiloxane hardener of example 4.

The composition of the coatings is shown in Table E.

TABLE E

| Compositions | Weight (grams) | | | | |
|---|---|---|---|---|---|
| Coating number | 1 | 2 | 3 | 4 | 5 |
| Pigmented base component | | | | | |
| Bis. A epoxy resin, | 60 | 32 | — | — | — |
| 75 wt % solution In xylene, | | | | | |
| Epoxy eq. wt. = 610-640 g/eq | | | | | |
| Hydrogenated Bis. A epoxy | — | — | — | 24 | 24 |
| resin, | | | | | |
| Epoxy eq. wt. = 210-238 g/eq | | | | | |
| Thixotrope agent | 0.5 | 0.5 | — | 0.5 | 0.5 |
| Defoamer | 0.5 | 0.5 | — | 0.5 | 0.5 |
| Titanium dioxide | 41.5 | 41.5 | — | 41.5 | 41.5 |
| Dow Coming 3074 | — | 36 | — | 36 | 36 |
| Hindered Amine Light Stabilizer | 1.5 | 1.5 | — | 1.5 | 1.5 |
| Catalyst | 1 | 2 | — | 2 | 2 |
| Xylene | 30 | 8 | — | 4 | 4 |
| PSX 700 Resin | — | — | 110 | — | — |
| Total | 135 | 122 | 110 | 110 | 110 |
| EEW [g/eq.] | 1406 | 2383 | — | 995 | 995 |
| Hardener component | | | | | |
| Silres 44100 VP | 23.7 | 12.6 | — | 27.3 | — |
| Hardener of example 4 | — | — | — | — | 31.1 |
| PSX 700 Cure | — | — | 17.9 | — | — |
| AHEW [g/eq.] | 247 | 247 | — | 247 | 281 |

### Example 17

### Gloss Retention Measurement

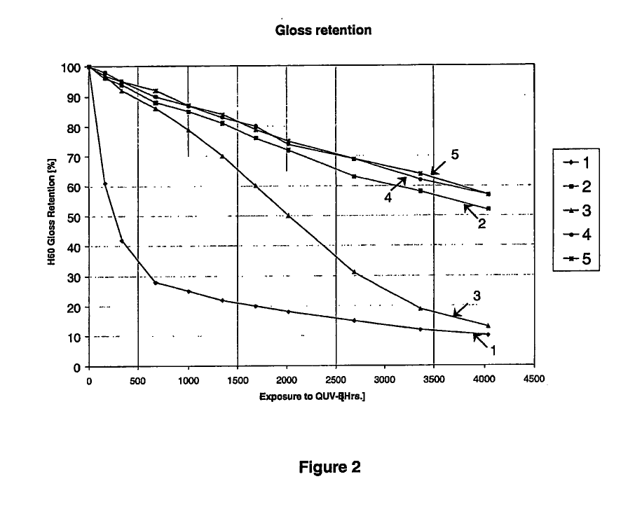

The determination of the gloss retention was done according to ASTM G53, in QUV-B testing (313 nm peak wavelength). The test was designed to accelerate the testing of weathering resistance of coatings by UV lights. Test panels are exposed to alternating ultraviolet and humidity cycles. They are checked periodically and degradation is measured by loss of gloss. The results are shown in Table F and FIG. 2.

TABLE F

Gloss retention
[%]

| Hours | Coating 1 | Coating 2 | Coating 3 | Coating 4 | Coating 5 |
|---|---|---|---|---|---|
| 0 | 100 | 100 | 100 | 100 | 100 |
| 168 | 61 | 96 | 97 | 98 | 97 |
| 336 | 42 | 94 | 92 | 95 | 95 |
| 672 | 28 | 88 | 86 | 90 | 92 |
| 1008 | 25 | 85 | 79 | 87 | 87 |
| 1344 | 22 | 81 | 70 | 83 | 84 |
| 1680 | 20 | 76 | 60 | 80 | 79 |
| 2016 | 18 | 72 | 50 | 74 | 75 |
| 2688 | 15 | 63 | 31 | 69 | 69 |
| 3360 | 12 | 58 | 19 | 62 | 64 |
| 4032 | 10 | 52 | 13 | 57 | 57 |

This test clearly shows that epoxy-polysiloxane coating compositions according to the invention have better gloss retention, weathering and UV resistance when compared to comparative epoxy coating 1. The compositions according to the invention therefore provide high gloss coatings with excellent UV resistance and gloss retention

### Example 18

### Specific Examples of Amino-Functional Polysiloxanes According to the Invention are Described Hereunder in Table 1

Examples of functional polysiloxane according to the invention may contain units of formula (A) and (B), in an alternating and/or in a random fashion, wherein the hydroxy and/or alkoxy group —OR⁶ are replaced by 10-100% of —O—R⁹, preferably by 20-100% of —O—R⁹, most preferably by 30-100% of —O—R⁹.

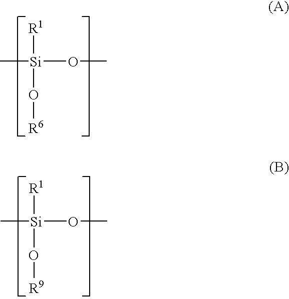

TABLE 1

| R¹ | R⁶ | R⁹ |
|---|---|---|
| phenyl and/or C₁₋₈alkyl | H | 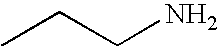 |
| phenyl and/or C₁₋₈alkyl | H | 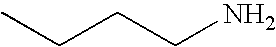 |
| phenyl and/or C₁₋₈alkyl | H | 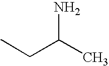 |
| phenyl and/or C₁₋₈alkyl | H | 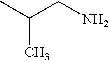 |
| phenyl and/or C₁₋₈alkyl | H | 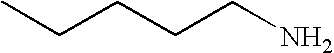 |
| phenyl and/or C₁₋₈alkyl | H | 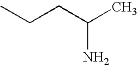 |
| phenyl and/or C₁₋₈alkyl | H | 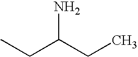 |
| phenyl and/or C₁₋₈alkyl | H | 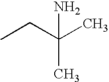 |
| phenyl and/or C₁₋₈alkyl | H | 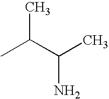 |
| phenyl and/or C₁₋₈alkyl | H | 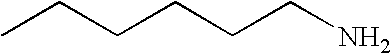 |
| phenyl and/or C₁₋₈alkyl | H | 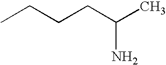 |
| phenyl and/or C₁₋₈alkyl | H | 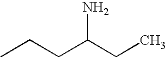 |
| phenyl and/or C₁₋₈alkyl | H | 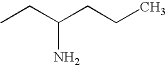 |
| phenyl and/or C₁₋₈alkyl | H | 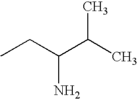 |
| phenyl and/or C₁₋₈alkyl | H | 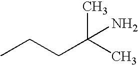 |
| phenyl and/or C₁₋₈alkyl | H | 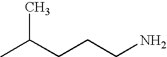 |
| phenyl and/or C₁₋₈alkyl | H | 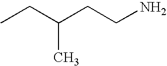 |
| phenyl and/or C₁₋₈alkyl | H | 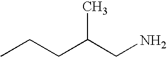 |
| phenyl and/or C₁₋₈alkyl | H | 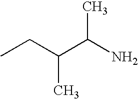 |
| phenyl and/or C₁₋₈alkyl | H | 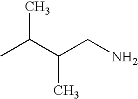 |
| phenyl and/or C₁₋₈alkyl | H | 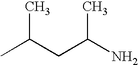 |
| phenyl and/or C₁₋₈alkyl | H | 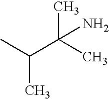 |
| phenyl and/or C₁₋₈alkyl | H | 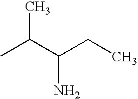 |
| phenyl and/or C₁₋₈alkyl | H | 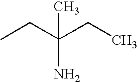 |
| phenyl and/or C₁₋₈alkyl | H | 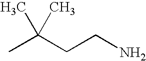 |
| phenyl and/or C₁₋₈alkyl | H | 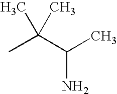 |
| phenyl and/or C₁₋₈alkyl | H | 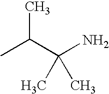 |
| phenyl and/or C₁₋₈alkyl | H | 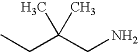 |
| phenyl and/or C₁₋₈alkyl | H | 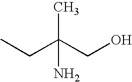 |
| phenyl and/or C₁₋₈alkyl | H | 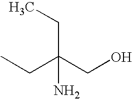 |
| phenyl and/or C₁₋₈alkyl | H | 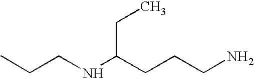 |
| phenyl and/or C₁₋₈alkyl | H | 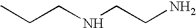 |
| phenyl and/or C₁₋₈alkyl | H | 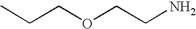 |
| phenyl and/or C₁₋₈alkyl | Me | 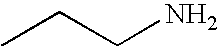 |
| phenyl and/or C₁₋₈alkyl | Me | 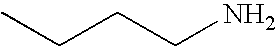 |
| phenyl and/or C₁₋₈alkyl | Me | 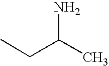 |
| phenyl and/or C₁₋₈alkyl | Me | 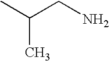 |
| phenyl and/or C₁₋₈alkyl | Me | 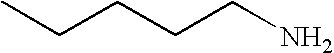 |
| phenyl and/or C₁₋₈alkyl | Me | 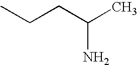 |
| phenyl and/or C₁₋₈alkyl | Me | 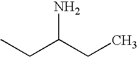 |
| phenyl and/or C₁₋₈alkyl | Me | 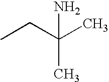 |
| phenyl and/or C₁₋₈alkyl | Me | 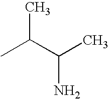 |
| phenyl and/or C₁₋₈alkyl | Me | 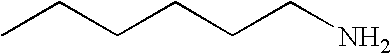 |
| phenyl and/or C₁₋₈alkyl | Me | 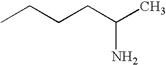 |
| phenyl and/or C₁₋₈alkyl | Me | 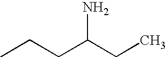 |
| phenyl and/or C₁₋₈alkyl | Me | 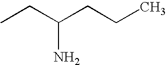 |
| phenyl and/or C₁₋₈alkyl | Me | 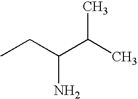 |
| phenyl and/or C₁₋₈alkyl | Me | 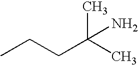 |
| phenyl and/or C₁₋₈alkyl | Me | 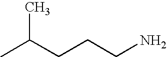 |
| phenyl and/or C₁₋₈alkyl | Me | 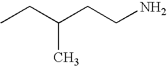 |
| phenyl and/or C₁₋₈alkyl | Me | 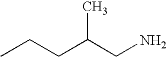 |
| phenyl and/or C₁₋₈alkyl | Me | 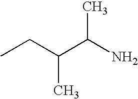 |
| phenyl and/or C₁₋₈alkyl | Me | 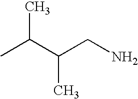 |
| phenyl and/or C₁₋₈alkyl | Me | 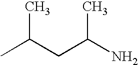 |
| phenyl and/or C₁₋₈alkyl | Me | 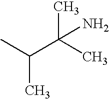 |
| phenyl and/or C₁₋₈alkyl | Me | 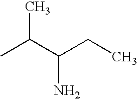 |
| phenyl and/or C₁₋₈alkyl | Me | 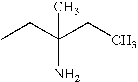 |
| phenyl and/or C₁₋₈alkyl | Me | 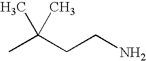 |
| phenyl and/or C₁₋₈alkyl | Me | 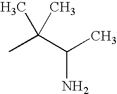 |
| phenyl and/or C₁₋₈alkyl | Me | 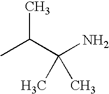 |
| phenyl and/or C₁₋₈alkyl | Me | 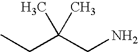 |
| phenyl and/or C₁₋₈alkyl | Me | 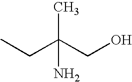 |
| phenyl and/or C₁₋₈alkyl | Me | 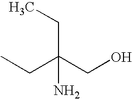 |
| phenyl and/or C₁₋₈alkyl | Me | 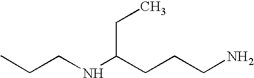 |
| phenyl and/or C₁₋₈alkyl | Me | 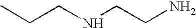 |
| phenyl and/or C₁₋₈alkyl | Me | 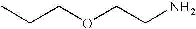 |
| phenyl and/or C₁₋₈alkyl | Bu | 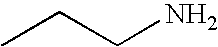 |
| phenyl and/or C₁₋₈alkyl | Bu | 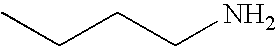 |
| phenyl and/or C₁₋₈alkyl | Bu | 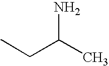 |
| phenyl and/or C₁₋₈alkyl | Bu | 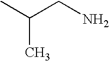 |
| phenyl and/or C₁₋₈alkyl | Bu | 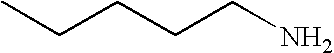 |
| phenyl and/or C₁₋₈alkyl | Bu | 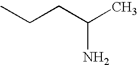 |
| phenyl and/or C₁₋₈alkyl | Bu | 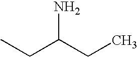 |
| phenyl and/or C₁₋₈alkyl | Bu | 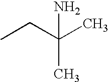 |
| phenyl and/or C₁₋₈alkyl | Bu | 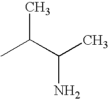 |
| phenyl and/or C₁₋₈alkyl | Bu | 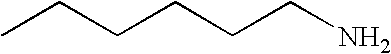 |
| phenyl and/or C₁₋₈alkyl | Bu | 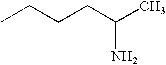 |
| phenyl and/or C₁₋₈alkyl | Bu | 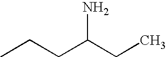 |
| phenyl and/or C₁₋₈alkyl | Bu | 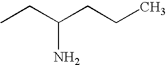 |
| phenyl and/or C₁₋₈alkyl | Bu | 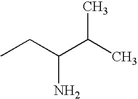 |
| phenyl and/or C₁₋₈alkyl | Bu | 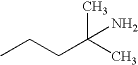 |
| phenyl and/or C₁₋₈alkyl | Bu | 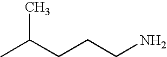 |
| phenyl and/or C₁₋₈alkyl | Bu | 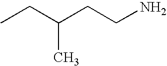 |
| phenyl and/or C₁₋₈alkyl | Bu | 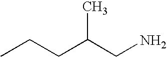 |
| phenyl and/or C₁₋₈alkyl | Bu | 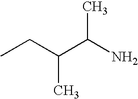 |
| phenyl and/or C₁₋₈alkyl | Bu | 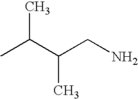 |
| phenyl and/or C₁₋₈alkyl | Bu | 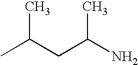 |
| phenyl and/or C₁₋₈alkyl | Bu | 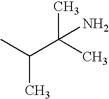 |
| phenyl and/or C₁₋₈alkyl | Bu | 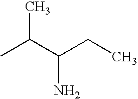 |
| phenyl and/or C₁₋₈alkyl | Bu | 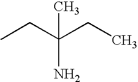 |
| phenyl and/or C₁₋₈alkyl | Bu | 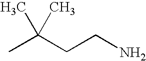 |
| phenyl and/or C₁₋₈alkyl | Bu | 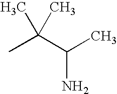 |
| phenyl and/or C₁₋₈alkyl | Bu | 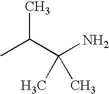 |
| phenyl and/or C₁₋₈alkyl | Bu | 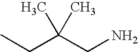 |
| phenyl and/or C₁₋₈alkyl | Bu | 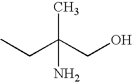 |
| phenyl and/or C₁₋₈alkyl | Bu | 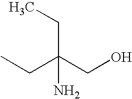 |
| phenyl and/or C₁₋₈alkyl | Bu | 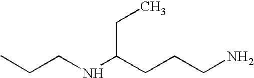 |
| phenyl and/or C₁₋₈alkyl | Bu | 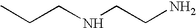 |
| phenyl and/or C₁₋₈alkyl | Bu | 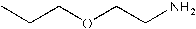 |

Although the amino-functional polysiloxane of the present invention have been described with considerable detail with reference to certain preferred variations thereof, other variations are possible. Therefore, the spirit and scope of the appended claims should not be limited to the preferred variations described herein.

1-44. (canceled)

45. A method of using an amino-functional polysiloxane of formula (1) as a hardener 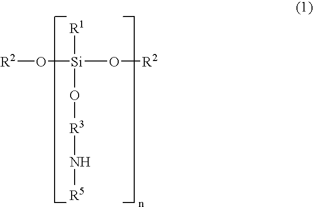
wherein each R¹ is independently selected from the group consisting of alkyl and aryl radicals, each R² is independently selected from the group consisting of hydrogen, alkyl and aryl radicals, n is selected so that the molecular weight for the functional polysiloxane is in the range of from 400 to 10,000 and R³ is a bivalent radical or —O—R³—NH—R⁵ is replaced by hydroxy or alkoxy, and R⁵ is selected from the group consisting of hydrogen, aminoalkyl, aminoalkenyl, aminoaryl, aminocycloalkyl radical, and wherein 0 to 90% of —O—R³—NH—R⁵ is replaced by hydroxy or alkoxy.

46. The method according to claim 45, wherein R⁵ is further substituted by one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl and alkynyl.

47. The method of using an amino-functional polysiloxane of formula (1) as a hardener according to claim 45, having the following stoichiometric formula
$${R}_{a}^{1} {{R}_{b}^{2} ( {R}^{9} O )}_{c} {SiO}_{\frac{( 4 - a - b - c )}{2}} ,$$
wherein each R¹ is independently selected from the group consisting of alkyl and aryl radicals, each R² is independently selected from the group consisting of hydrogen, alkyl and aryl radicals, each R⁹ is independently selected from hydrogen, alkyl, or —R³—NH—R⁵, a and b are each a real number from 0.0 to 2.0, more in particular from 0.1 to 2.0, c is a real number from 0.1 to 1.0, b/a is ranging from 0.2-2.0 and a+b+c is lower than 4, wherein R³ is a bivalent radical and R⁵ is selected from the group consisting of hydrogen, aminoalkyl, aminoalkenyl, aminoaryl, aminocycloalkyl radical, wherein 0 to 90% of —O—R⁹ is hydroxy or alkoxy.

48. The method according to claim 47, wherein R⁵ is further substituted by one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl and alkynyl.

49. The method according to claim 45, wherein R³ is selected from the group consisting of alkylene, alkyleneoxy, alkenylene, arylene, aralkylene, aralkenylene, aminoalkylene, alkyleneoxyaralkyloxyalkylene, CH₂-phenyl-(CH₂)ₙ—, -phenyl-(CH₂)ₙ—, —C(═O)—, —C(═S)—, —S(═O)₂—, alkylene-C(═O)—, alkylene-C(═S)—, alkylene-S(═O)₂—, —NR⁴—C(═O)—, —NR⁴-alkylene-C(═O)—, and —NR⁴—S(═O)₂ whereby either the C(═O) group or the S(═O)₂ group is attached to the NR⁴ moiety, wherein R⁴ is hydrogen, alkyl, alkenyl, aralkyl, cycloalkyl, cycloalkylalkyl, aryl, heterocycle or heterocycloalkyl.

50. The method according to claim 49, wherein R³ is further substituted by one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, alkylcarboxy, ester, alkylester, ether, esteroxy, sulfonic acid, sulfonyl derivatives, sulfinyl derivatives, heterocycle, alkenyl and alkynyl.

51. The method according to claim 49, wherein R³ is alkylene, substituted alkylene, alkenylene, substituted alkenylene, arylene, substituted arylene, aralkylene, substituted aralkylene, aralkenylene, substituted aralkenylene, aminoalkylene, substituted aminoalkylene, alkyleneoxy, substituted alkyleneoxy, alkyleneoxyaralkyloxyalkylene, substituted alkyleneoxyaralkyloxyalkylene, CH₂-phenyl-(CH₂)ₙ—, substituted CH₂-phenyl-(CH₂)ₙ—, -phenyl-(CH₂)ₙ— and substituted -phenyl-(CH₂)ₙ—, wherein the substitution comprises one or more radicals selected from the group consisting of alkyl, aryl, cycloalkyl, hydroxy, alkoxy, thioalkyl, amino, amino derivatives, amido, amidoxy, acyl derivatives, acyloxy derivatives, carboxy, alkylcarboxy, ester, alkylester, ether, esteroxy, heterocycle, alkenyl and alkynyl.

52. The method according to claim 45, wherein the radical —O—R³—NH—R⁵ is a radical of formula (1′), 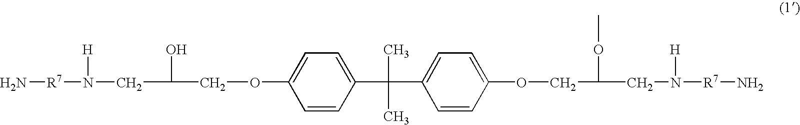
wherein R⁷ is selected from the group consisting of alkyl, substituted alkyl, alkenyl, substituted alkenyl, aryl, substituted aryl, cycloalkyl radical, and substituted cycloalkyl radical, wherein the substitution comprises one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl and alkynyl.

53. The method according to claim 45, wherein said aminopolysiloxane is of formula (2′) 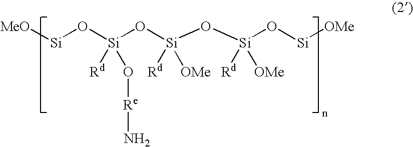
wherein R^{d} is an alkyl or an aryl and R^{e} is selected from the group consisting of alkylene, substituted alkylene, alkenylene, substituted alkenylene, arylene, substituted arylene, aralkylene, substituted aralkylene, aralkenylene, substituted aralkenylene, aminoalkylene, substituted aminoalkylene, alkyleneoxy, substituted alkyleneoxy, alkyleneoxyaralkyloxyalkylene, substituted alkyleneoxyaralkyloxyalkylene, CH₂-phenyl-(CH₂)ₙ—, substituted CH₂-phenyl-(CH₂)ₙ—, -phenyl-(CH₂)ₙ—, and substituted -phenyl-(CH₂)ₙ—, wherein the substitution comprises one or more radicals selected from the group consisting of alkyl, aryl, cycloalkyl, hydroxy, alkoxy, thioalkyl, amino, amino derivatives, amido, amidoxy, acyl derivatives, acyloxy derivatives, carboxy, alkylcarboxy, ester, alkylester, ether, esteroxy, heterocycle, alkenyl and alkynyl.

54. The method according to claim 45, wherein said amino-functional polysiloxane contains units of formula (A) and (B), in an alternating and/or in a random fashion, wherein the hydroxy and/or alkoxy group —OR⁶ are replaced by 10-100% of —O—R⁹, preferably by 20-100% of —O—R⁹, most preferably by 30-100% of —O—R⁹, 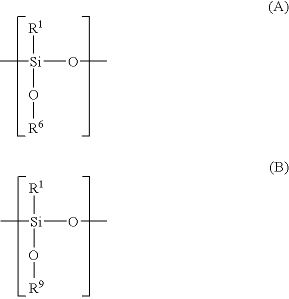
wherein R¹ is phenyl and/or C₁₋₈alkyl, R⁶ is H, Me or Bu, and R⁹ is selected from the group consisting of the following formula:

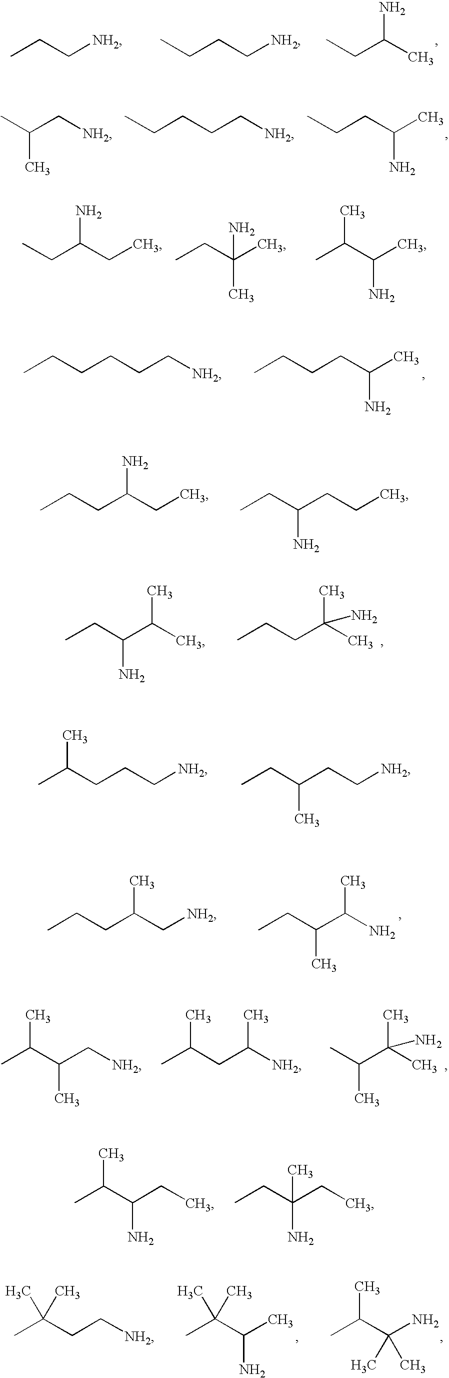

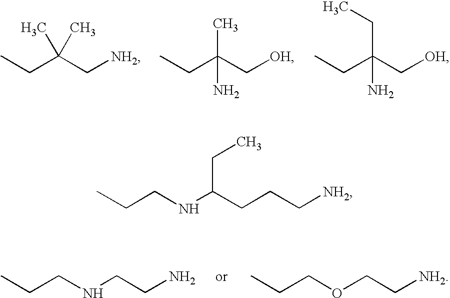

55. The method according to claim 54, wherein —OR⁶ are replaced by 20-100% of —O—R⁹.

56. The method according to claim 54, wherein —OR⁶ are replaced by 30-100% of —O—R⁹.

57. The method according to claim 45, wherein the hardener is used in a coating.

58. A polymer composition comprising an amino-functional polysiloxane of formula (1) as defined in claim 45 and an epoxy resin.

59. The polymer composition of claim 58, further comprising a polysiloxane resin

60. The polymer composition of claim 58, further comprising a catalyst

61. The polymer composition according to claim 58, wherein the amino-functional polysiloxane is ranging from 40 to 80% by weight and epoxy resin is ranging from 20 to 60% by weight.

62. A method for the preparation of a polymer composition comprising an amino-functional polysiloxane of formula (1) and an epoxy resin, comprising the step of mixing an amino-functional polysiloxane of formula (1) as defined in claim 45, with an epoxy resin.

63. The method of claim 62, wherein the method further comprises mixing a polysiloxane resin with the functional polysiloxane of formula (1).

64. The method of claim 62, wherein the method further comprises mixing a catalyst.

65. An epoxy-polysiloxane composition obtainable by combining the following ingredients:
a polysiloxane of formula (4), wherein each R^{1′} is independently selected from the group consisting of hydroxy, alkyl, aryl and alkoxy radicals having up to six carbon atoms, each R² is independently selected from the group consisting of hydrogen, alkyl and aryl radicals having up to six carbon atoms and, wherein n is selected so that the molecular weight for the polysiloxane is in the range of from about 400 to 10,000, with 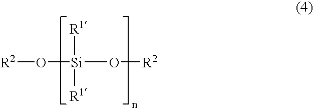
an epoxy resin having more than one 1,2-epoxy groups per molecule with an epoxy equivalent weight in the range of from 100 to about 5,000; and
an aminopolysiloxane hardener component or an amino-functional polysiloxane hardener component according to claim 45, having active hydrogens able to react with the epoxy groups in the epoxy resin to form epoxy polymers, and able to react with the polysiloxane to form polysiloxane polymers, wherein the epoxy chain polymers and polysiloxane polymers polymerize to form a cured epoxy-polysiloxane polymer composition.

66. The composition according to claim 65, wherein the aminopolysiloxane hardener is an amino-functional polysiloxane of formula (1) 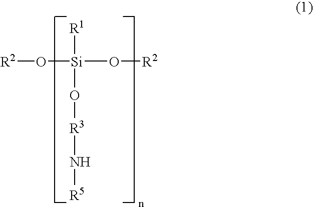
wherein each R¹ is independently selected from the group consisting of alkyl and aryl radicals, each R² is independently selected from the group consisting of hydrogen, alkyl and aryl radicals, n is selected so that the molecular weight for the functional polysiloxane is in the range of from 400 to 10,000 and R³ is a bivalent radical or —O—R³—NH—R⁵ is replaced by hydroxy or alkoxy, and R⁵ is selected from the group consisting of hydrogen, aminoalkyl, substituted aminoalkyl, aminoalkenyl, substituted aminoalkenyl, aminoaryl, substituted aminoaryl, aminocycloalkyl radical, and substituted aminocycloalkyl radical, wherein the substitution comprises one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl and alkynyl and wherein 0 to 90% of —O—R³—NH—R⁵ is hydroxy or alkoxy.

67. The composition according to claim 66, wherein the amino-functional polysiloxane of formula (1), has the following stoichiometric formula
$${R}_{a}^{1} {{R}_{b}^{2} ( {R}^{9} O )}_{c} {SiO}_{\frac{( 4 - a - b - c )}{2}} ,$$
wherein each R¹ is independently selected from the group consisting of alkyl and aryl radicals, each R² is independently selected from the group consisting of hydrogen, alkyl and aryl radicals, each R⁹ is independently selected from hydrogen, alkyl, or —R³—NH—R⁵, a and b are each a real number from 0.0 to 2.0, c is a real number from 0.1 to 1.0, b/a is ranging from 0.2-2.0 and a+b+c is lower than 4, wherein R³ is a bivalent radical and R⁵ is selected from the group consisting of hydrogen, aminoalkyl, substituted aminoalkyl. aminoalkenyl, substituted aminoalkenyl, aminoaryl, substituted aminoaryl, aminocycloalkyl radical, and substituted aminocycloalkyl radical, wherein the substitution comprises one or more radicals selected from the group consisting of by alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl and alkynyl, wherein 0 to 90% of —O—R⁹ is hydroxy or alkoxy.

68. The composition of claim 67, wherein a and b are each a real number from 0.1 to 2.0,

69. The composition according to claim 66, wherein R³ is selected from the group consisting of alkylene, alkyleneoxy, alkenylene, arylene, aralkylene, aralkenylene, aminoalkylene, alkyleneoxyaralkyloxyalkylene, CH₂-phenyl-(CH₂)ₙ—, -phenyl-(CH₂)ₙ—, —C(═O)—, —C(═S)—, —S(═O)₂—, alkylene-C(═O)—, alkylene-C(═S)—, alkylene-S(═O)₂—, —NR⁴—C(═O)—, —NR⁴-alkylene-C(═O)—, and —NR⁴—S(═O)₂ whereby either the C(═O) group or the S(═O)₂ group is attached to the NR⁴ moiety, wherein R⁴ is hydrogen, alkyl, alkenyl, aralkyl, cycloalkyl, cycloalkylalkyl, aryl, heterocycle or heterocycloalkyl.

70. The composition according to claim 69, wherein R³ is further substituted by one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, alkylcarboxy, ester, alkylester, ether, esteroxy, sulfonic acid, sulfonyl derivatives, sulfinyl derivatives, heterocycle, alkenyl and alkynyl.

71. The composition according to claim 69, wherein R³ is selected from the group consisting of alkylene, substituted alkylene, alkenylene, substituted alkenylene, arylene, substituted arylene, aralkylene, substituted aralkylene, aralkenylene, substituted aralkenylene, aminoalkylene, substituted aminoalkylene, alkyleneoxy, substituted alkyleneoxy, alkyleneoxyaralkyloxyalkylene, substituted alkyleneoxyaralkyloxyalkylene, CH₂-phenyl-(CH₂)ₙ—, substituted CH₂-phenyl-(CH₂)ₙ—, -phenyl-(CH₂)ₙ—, and substituted -phenyl-(CH₂)n—, wherein the substitution comprises one or more radicals selected from the group consisting of alkyl, aryl, cycloalkyl, hydroxy, alkoxy, thioalkyl, amino, amino derivatives, amido, amidoxy, acyl derivatives, acyloxy derivatives, carboxy, alkylcarboxy, ester, alkylester, ether, esteroxy, heterocycle, alkenyl and alkynyl.

72. The composition according to claim 66, wherein the radical —O—R³—NH—R⁵ is a radical of formula (1′), 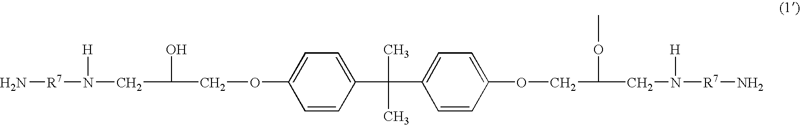
wherein R⁷ is selected from the group consisting of alkyl, substituted alkyl, alkenyl, substituted alkenyl, aryl, substituted aryl, cycloalkyl radical, and substituted cycloalkyl radical, wherein the substitution comprises one or more radicals selected from the group consisting of alkyl, aryl, cycloalkyl, halogen, hydroxy, alkoxy, thioalkyl, amino, amino derivatives, amido, amidoxy, nitro, cyano, keto, acyl derivatives, acyloxy derivatives, carboxy, ester, ether, esteroxy, heterocycle, alkenyl and alkynyl.

73. Composition according to claim 66, wherein R⁵ is selected from the group consisting of H₂N(CH₂)₃—, H₂N(CH₂)₂—, H₂N(CH₂)₄—, H₂N—(CH₂)₂—NH—(CH₂)₂—, and C₄H₉—NH(CH₂)₂NH(CH₂)₂—.

74. The composition according to claim 65, wherein said aminopolysiloxane is of formula (2′) 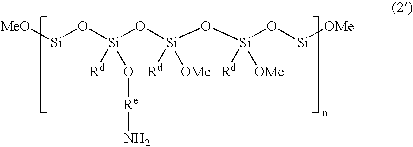
wherein R^{d} is an alkyl or an aryl and R^{e} is selected from the group consisting of alkylene, substituted alkylene, alkenylene, substituted alkenylene, arylene, substituted arylene, aralkylene, substituted aralkylene, aralkenylene, substituted aralkenylene, aminoalkylene, substituted aminoalkylene, alkyleneoxy, substituted alkyleneoxy, alkyleneoxyaralkyloxyalkylene, substituted alkyleneoxyaralkyloxyalkylene, CH₂-phenyl-(CH₂)ₙ—, substituted CH₂-phenyl-(CH₂)ₙ—, -phenyl-(CH₂)ₙ—, and substituted -phenyl-(CH₂)ₙ—, wherein the substitution comprises one or more radicals selected from the group consisting of alkyl, aryl, cycloalkyl, hydroxy, alkoxy, thioalkyl, amino, amino derivatives, amido, amidoxy, acyl derivatives, acyloxy derivatives, carboxy, alkylcarboxy, ester, alkylester, ether, esteroxy, heterocycle, alkenyl and alkynyl.

75. The composition according to claim 74, wherein R^{d} is selected from the group consisting of methyl, ethyl, propyl and phenyl; and R^{e} is selected from the group consisting of methylene, ethylene and propylene.

76. The composition according to claim 65, wherein said aminopolysiloxane is selected from the group consisting of amino-functional polysiloxanes containing units of formula (A) and (B), in an alternating and/or in a random fashion, wherein the hydroxy and/or alkoxy group —OR⁶ are replaced by 10-100% of —O—R⁹, preferably by 20-100% of —O—R⁹, most preferably by 30-100% of —O—R⁹, 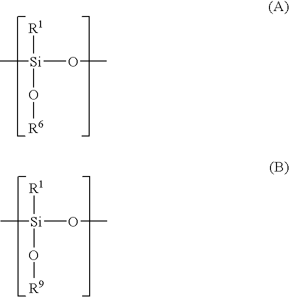
wherein R¹ is phenyl and/or C₁₋₈alkyl, R⁶ is H, Me or Bu, and R⁹ is selected from the group consisting of the following formula:

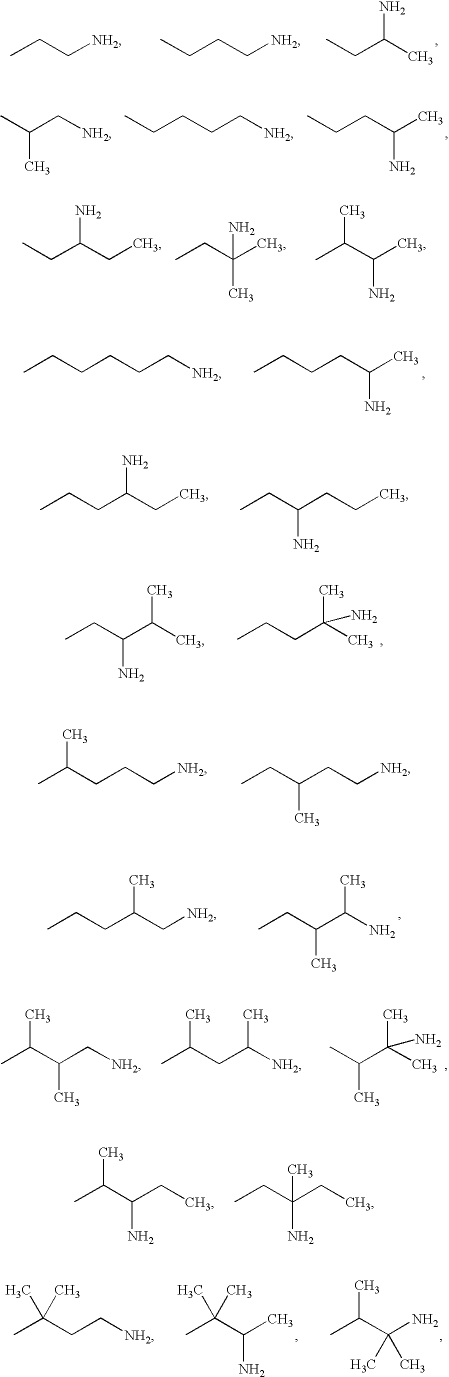

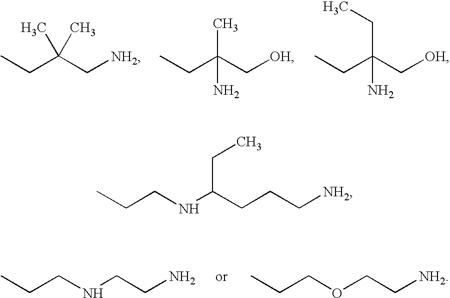

77. The composition according to claim 76, wherein the hydroxy and/or alkoxy group —OR⁶ are replaced by 20-100% of —O—R⁹.

78. The composition according to claim 76, wherein the hydroxy and/or alkoxy group —OR⁶ are replaced by 30-100% of —O—R⁹.

79. The composition according to claim 65, wherein the epoxy resin is a non-aromatic epoxy resin.

80. The composition according to claim 79, wherein the epoxy resin is a non-aromatic hydrogenated epoxy resin.

81. The composition according to claim 79, wherein the non-aromatic epoxy resin is selected from the group of cycloaliphatic epoxy resins consisting of diglycidyl ethers of cyclohexane dimethanol and diglycidyl ethers of hydrogenated bisphenol A epoxy resins.

82. The composition according to claim 65, wherein the composition additionally comprises at least one metal catalyst to facilitate cure at ambient temperature, wherein the catalyst is selected from the group consisting of zinc, manganese, zirconium, titanium, cobalt, iron, lead, and tin containing driers.

83. The composition according to claim 65, comprising at least one additional ingredient selected from the group consisting of rheological modifiers, plasticizers, antifoam agents, thixotropic agents, pigment-wetting agents, adhesion promoters, anti-settling agents, diluents, UV light stabilizers, air release agents, dispersing aids, and mixtures thereof.

84. The composition according to claim 65, further comprising a pigment or filler material having a fine particle size selected from the group consisting of organic and inorganic pigments, wherein at least 90% by weight of the pigment being smaller than 40 microns particle size.

85. The composition according to claim 65 comprising in the range of from about 10 to 80% by weight polysiloxane, 10 to 50% by weight of the epoxy resin ingredient, 5-40% by weight of the aminopolysiloxane hardener.

86. The composition according to claim 85, further comprising up to about 5% by weight catalyst.

87. A method for the preparation of an epoxy-polysiloxane polymer composition comprising the steps of combining:
a polysiloxane of formula (4), wherein each R^{1′} is independently selected from the group consisting of hydroxy, alkyl, aryl and alkoxy radicals having up to six carbon atoms, each R² is independently selected from the group consisting of hydrogen, alkyl and aryl radicals having up to six carbon atoms and, wherein n is selected so that the molecular weight for the polysiloxane is in the range of from about 400 to 10,000; with 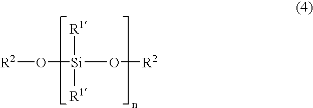
an epoxy resin having more than one 1,2-epoxy groups per molecule with an epoxy equivalent weight in the range of from 100 to about 5,000;
a sufficient amount of an aminopolysiloxane hardener or an amino-functional polysiloxane hardener according to claim 45 having active hydrogens, and
a sufficient amount of water to facilitate hydrolysis and polycondensation reactions to form the fully-cured cross-linked epoxy-polysiloxane polymer composition at ambient temperature.

88. The method according to claim 87 further comprising combining the polysiloxane with a catalyst.

89. The method according to claim 87, wherein said polysiloxane is selected from the group consisting of alkoxy- and silanol-functional polysiloxanes having a molecular weight in the range of from about 400 to 10,000.

90. A substrate provided with at least one layer of a cured network according to claim 65.

91. A method for making a fully-cured thermosetting epoxy-polysiloxane composition comprising the steps of:
forming a base component by combining:
an epoxy resin having more than one 1,2-epoxy groups per molecule with an epoxy equivalent weight in the range of from 100 to about 5,000;
a polysiloxane of formula (4), wherein each R^{1′} is independently selected from the group consisting of hydroxy, alkyl, aryl and alkoxy radicals having up to six carbon atoms, each R² is independently selected from the group consisting of hydrogen, alkyl and aryl radicals having up to six carbon atoms and, wherein n is selected so that the molecular weight for the polysiloxane is in the range of from about 400 to 10,000; with 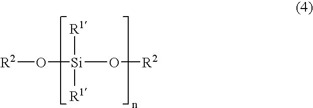
curing the base component at ambient temperature by adding thereto:
an aminopolysiloxane hardener or an amino-functional polysiloxane hardener according to claim 45 with active hydrogens able to react with epoxy groups in the epoxy resin to form polymers containing hydroxyl groups, which are able to react with the silanol groups of hydrolyzed polysiloxane to form a polymer network, wherein the epoxy chain polymers and polysiloxane polymers polymerize to form a fully-cured epoxy-polysiloxane polymer composition.

92. The method according to claim 91 which further comprises adding a catalyst to facilitate curing the base component at ambient temperature.

93. The method according to claim 91, wherein said polysiloxane is selected from the group consisting of alkoxy- and silanol-functional polysiloxanes having a molecular weight in the range of from 400 to 10,000.
